(19) United States
(12) Patent Application Publication
(10) Pub. No.: US 2010/0262432 A1
(43) Pub. Date: Oct. 14, 2010

(54) Computer-created-consensus-based health-care system

(76) Inventor: Anuthep Benja-Athon, New York, NY (US)

Correspondence Address: ANUTHER BENJA-ATHON, M.D., 210 E 36th St., New York, NY, 10016, US

(21) Appl. No.: 12/799,207

(22) Filed: Apr. 21, 2010

Related U.S. Application Data
(63) Continuation-in-part of application No. 12/658,112, filed on Feb. 3, 2010.
Application No. 12/658,112 is a continuation-in-part of application No. 12/655,748, filed on Jan. 7, 2010.
Application No. 12/655,748 is a continuation-in-part of application No. 12/592,714, filed on Dec. 2, 2009.
Application No. 12/592,714 is a continuation-in-part of application No. 12/381,654, filed on Mar. 16, 2009.
Application No. 12/381,654 is a continuation-in-part of application No. 12/322,529, filed on Feb. 4, 2009.
Application No. 12/322,529 is a continuation-in-part of application No. 12/321,141, filed on Jan. 16, 2009.
Application No. 12/321,141 is a continuation-in-part of application No. 12/080,433, filed on Apr. 3, 2008.
Application No. 12/080,433 is a continuation-in-part of application No. 12/069,409, filed on Feb. 11, 2008.
Application No. 12/069,409 is a continuation-in-part of application No. 11/986,657, filed on Nov. 26, 2007, now abandoned.
Application No. 11/986,657 is a continuation-in-part of application No. 11/803,621, filed on May 16, 2007.
Application No. 11/803,621 is a continuation-in-part of application No. 11/716,062, filed on Mar. 9, 2007.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006, now abandoned.
Application No. 11/599,847 is a continuation-in-part of application No. 11/431,046, filed on May 10, 2006, now abandoned.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006, now abandoned.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007, now abandoned.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.
Application No. 11/022,410 is a continuation-in-part of application No. 09/191,795, filed on Nov. 13, 1998, now Pat. No. 6,132,218.

(51) Int. Cl. G06Q 50/00; G06Q 10/00; G06F 17/30

(52) U.S. Cl. 705/2; 707/802; 707/E17.005

(57) ABSTRACT

The system and method for applying interactive and adaptable consensuses, guidelines and protocols comprising electronic templates comprising relational information and data for managing and delivering better and optimal health, health-care and health-care services by computer servers.

This application is a continuation-in-part of Ser. No. 12/658,112 entitled A system and method for computer-generations of diagnoses filed Feb. 3, 2010, a continuation-in-part of Ser. No. 12/655,748 entitled the Artificial-intelligent system and method for managing health-care filed Jan. 7, 2010, a continuation-in-part of Ser. No. 12/592,714 entitled the Healthcare Exchange IV filed Dec. 2, 2009, a continuation-in-part of Ser. No. 12/381,654 filed Mar. 16, 2009 entitled the Adaptable compositions of health information, a continuation-in-part of Ser. No. 12/322,529 entitled the Healthcare Exchange II filed Feb. 4, 2009, a continuation-in-part of Ser. No. 12/321,141 entitled the Best system of health and health-care data management filed Jan. 16, 2009, a continuation-in-part of Ser. No. 12/080,433 entitled The Healthcare Exchange filed Apr. 3, 2008, a continuation-in-part of Ser. No. 12/069,409 entitled the Filing of Health and Health-care data filed Feb. 11, 2008, continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007, a continuation-in-part of Ser. No. 11/637,662 entitled A vital hierarchy of data on diseases filed Dec. 13, 2006, a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/293,689 entitled A system of conserving health-care buyers' resources filed Dec. 5, 2005, a continuation-in-part of Ser. No. 11/150,878 entitled Physicians' optimal management of health information filed Jun. 13, 2005, a continuation-in-part of Ser. No. 11/074,236 entitled A system of management of health-care resources filed Mar. 7, 2005, a continuation-in-part of Ser. No. 11/022,410 entitled Physicians' way of information productions filed Dec. 27, 2004 which are pending and a continuation-in-part of U.S. Pat. No. 6,132,218 entitled Images for communication of medical information in computer granted Oct. 17, 2000 to this present patent applicant.

### FIELD OF INVENTION

Computer-created consensuses, guidelines and protocol for managing and deliveries of health and health-care services.

### BACKGROUND OF THE INVENTION

The practice of medicine and surgery remains a mixture of art and science and there is a proposal to base said practice of physicians on a proposed model of evidence-based medicine which will most likely not feasible and failures, disappointments, wastes and suffering, to say the least, will continue unabated in societies and nations for numerous facts. Furthermore, adverse events, conditions, settings and outcomes in the current health-care system are extremely common and pervasive in all nations including America and often blamed as physicians' inefficiency, lack of knowledge and experience, negligence and mal-practices.

However, the present invention uses and applications of uniquely innovative computer programs and software and commercially available programs and software and computer servers in a network or networks of computers, mobile devices and servers to realistically provides a system and method for improving and/or optimizing physicians' practice of medicine and delivery of health, health-care and health-care services to people based on physician-tested science at much lesser costs and losses to people including physicians and nations. Said adverse events, conditions, settings and outcomes are minimized or eliminated by the present invention.

Furthermore, as a significant initial step forward and advancement of medicine and health-care in the current millennium, the present invention is an even farther endeavor into the technological frontier of medicine, surgery and health-care. The present invention, in many settings and circumstances, exceeds the memory, reasoning, deductive, analytical and logical capabilities of physicians' brains. In brief, the present invention arose as an outcome of the embodiments in said patent applications and the current and continual research of the present applicant.

The present invention expedites and improves medical-decision and health-care processes and the managements of health-care services and deliveries of patients to serve said people and, together with said pending patent applications, are the only means and solution for solving the current health and health-care woes affecting all Americans and, consequently, they produce the best health-care system the world ever known and have and the global benefits for billions of people including physicians and patients and humanity are immense.

### SUMMARY OF THE INVENTION

Adverse events, conditions, settings and outcomes and medical and health consequences in the current health-care system are extremely common and pervasive in all nations including America and often it was erroneously blamed on physicians' inefficiency, lack of knowledge and experience, negligence and mal-practices. Heretofore, there were no solutions to said dilemmas and institutional approaches are neither realistic nor feasible.

The present invention provides as a system and method for solving said problems and dilemmas comprising a computerized electronic platform of interactive and adaptable pooled consensuses, guidelines and protocols for managing and delivering better and optimal qualities, quantities, managements and deliveries of health, health-care and health-care services for physicians by a computer server, computer servers or virtual server or servers. Said consensuses, guidelines and protocols comprising compiled, related and pooled relational information and data in the SQL database and/or databases are created and repetitively generated, edited, updated and improved by and in said computer server, computer servers or virtual server or servers.

### DESCRIPTION OF THE PREFERRED EMBODIMENTS

In fact, it is reasonable and accurate to claim that the preferred embodiments of the present invention epitomize, represent and, truly, are the first system and method for computer servers and devices in a network or networks of said servers and devices—a computer-intelligent entity possessing innovative computer programs, software and adaptable, improvable, expandable, immensely compiled, related and pooled relational information and data on medicine, health, health-care and health-care services—for managing qualities, quantities and deliveries of health, health-care and health-care services by physicians for billions of people. Further fact, the preferred embodiments of the present invention, in many settings and circumstances, exceed the performances and outputs of the memory, reasoning, deductive, analytical and logical capabilities of physicians' brains.

The present invention provides a method and a computerized electronic platform of interactive and adaptable pooled consensuses, guidelines and protocols created and generated in and by a computer server or servers for managing the qualities, quantities and deliveries of health, health-care and health-care services in a network or networks of computer servers and computers, portable and wireless electronic communication devices henceforth devices for physicians and patients.

The present invention first provides a computerized electronic platform of interactive and adaptable pooled consensuses, guidelines and protocols on the qualities, quantities, managements and deliveries of health, health-care and health-care services for physicians created, generated, improved and maintained by and in a computer server or servers possessing and operating memories, processors, at least a server operating system, a Windows Server, a SQL Server, a Visual Studio and .Net, computer scripting languages, Java script, AJAX, HTML, XHTML, a Microsoft IIS, Apache, a Web browser, Web server and the innovative and, invented by the present applicant, the unique innovative computer programs and software for commanding and communicating for commanding and communicating with said SQL Server and said relational data and/or databases and coupling with said computer scripting language and for creating, compiling, pooling and relating relational information and data in SQL database and/or databases comprising individual diagnoses, individual syndromes or diagnoses or syndromes in individual groups of diagnoses or syndromes affecting organs, parts and anatomical sites of humans and related diseases, disorders, chief complaints, differential diagnoses and, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties or practices repetitively generated by physicians and submitted to, compiled, related and pooled in said SQL database and/or databases in and manage by said SQL Server and for repetitively scanning or checking for redundant duplicates or repeats, doubles in said physicians' submissions, for removing said redundant duplicates or repeats, doubles relating to individual diagnoses from said SQL database and/or databases, for not inserting said redundant duplicates or repeats, doubles relating to individual diagnoses in said SQL database and/or databases and for compiling, pooling and relating relational information and data in said SQL database and/or databases and for repetitively creating, generating, managing, relating, updating, improving said relational information and data in said SQL database and/or databases and for repetitively creating, generating and displaying and enabling the uses of said individual interactive and adaptable electronic consensuses, guidelines and protocols in said computer server or servers. Said computer programs and software (plural) in said computer servers in said network or networks of computer servers and devices and the Internet effect the present invention and its applications and uses by people including physicians and patients using said devices to access and use the present invention.

The present invention also provides a process for operating in said computer server or servers in said network or networks of computer servers and devices and the Internet said unique and innovative computer programs and software for commanding and communicating with said SQL Server and said relational database and/or databases and coupling with said computer scripting language and for creating, compiling, pooling and relating relational data in said SQL database and/or databases in and manage by said SQL Server, for repetitively scanning and checking for redundant duplicates or repeats, doubles in individual physicians' submissions related to individual diagnoses or individual syndromes or diagnoses in individual groups of diagnoses and related relational data in said SQL database and/or databases, for removing said redundant duplicates or repeats, doubles from relational data in said SQL database and/or databases or for not inserting said redundant duplicates or repeats, doubles into said relational data in said SQL database and/or databases and for compiling, pooling and relating relational data in said SQL database and/or databases, for repetitively creating, generating, managing, relating, improving said relational data, for generating, improving, updating and inserting additional data into said compiled, related and pooled relational data in said SQL database and/or databases, for generating and displaying said compiled, related and pooled relational data in said individual consensuses, guidelines and protocols and for creating, generating and displaying and enabling the uses of said consensuses, guidelines and protocols in said computer server or servers by physicians using said devices.

To understand the preferred embodiments of the present invention, however, it is necessary to mention herein said earlier patent applications including pending patent applications such as, but not limited to, Ser. No. 12/381,654 entitled the Adaptable Compositions of Health Information, Ser. No. 12/592,714 entitled the Healthcare Exchange IV, Ser. No. 12/321,141 entitled The Best System of Health and Health-care Data Management Ser. No. 12/069,409 entitled the Filing of Health and Health-care data, Ser. No. 12/322,529 entitled the Healthcare Exchange II and Ser. No. 12/080,433 entitled The Healthcare Exchange. Said unique and innovative patent applications taught the use and implementation of the categories, headers or headings used and use by physicians in all medical and surgical practices such as, but not limited to, Evaluation, Diagnosis, Group of Diagnoses, Differential Diagnoses and related compiled or pooled information and data on Chief Complaint, Review of Systems, Physical Examination, Laboratory, Imaging, Body Fluid Tests and Tissue Examinations, Organs, Anatomical Sites and Parts, Family History, Genetics, Immunization and Physicians' Practice to enable and/or facilitate the organization, manipulation, processing and relating of health, health-care and health-care services generated and submitted by physicians in about 85 medical and surgical specialties. Each said category or heading encompasses a vast amount of information and data including words and terms on or relating to health, health-care and health-care services which are used by physicians of all and diverse medical and surgical practices or specialties for and in the communications of said information and data among and between said physicians and between physicians and patients. Said information and data including said words and terms are found in numerous medical dictionaries and medical and surgical text books, journals, publications, literature and encyclopedias, etc. of said all medical and surgical specialties. For example, in the Evaluation heading, said words and terms number about 20-40 or more and are such as, but not limited to, consultation, brief consultation, intermediate consultation, comprehensive consultation, office visit, brief office visit, intermediate office visit, examination, reexamination, follow-up, etc.; in the heading of Laboratory comprises imaging, blood and tissue tests, analyses and examinations, electro-diagnosis, said words and terms number approximately many hundreds such as, but not limited to, x-rays, MRI's, CTScan's, PET Scans of various parts of the body, various types of blood tests, urinalyses, pathological analyses which are used by physicians in about 85 medical and surgical specialties or practices. However, in each of other said headings, said words and terms are very extensive. For example, under Diagnosis heading, there are all words and terms used and use by physicians in about 85 medical and surgical specialties on diagnoses of human diseases, illnesses and disorders; in Treatment heading, there are all words and terms used and use by physicians in about 85 medical and surgical specialties on the treatments of human diseases, illnesses and disorders such as, but not limited to, medical acupuncture, excision drainage, trigger point injection, bursa injection, vaccinations, etc.; in the Surgery heading, there are all words and terms used and use by physicians in about 85 medical and surgical specialties on the surgeries and surgical procedures of human diseases, illnesses and disorders such as, but not limited to, burr hole, craniotomy, cholecystectomy, splenectomy, arthroscopy, endoscopy, resections, etc.; in Medication heading, there are all medications and related information present in the Physicians' Desk Reference used and use by physicians in about 85 medical and surgical specialties. Anatomical structures and names are also used.

As taught by said pending patent applications of the applicant of the present invention, there are at least four innovative methods and systems provided by said pending applications which are applied as one of the preferred embodiments of the innovative present invention enabling any and all individual physicians and doctors—tens to hundreds of thousands of physicians and doctors—from any and all medical and surgical specialties—in the course of or related to the caring and documenting diagnoses and related health, health-care and health-care services of and for patients and participating in the health and health-care endeavors created and effected by said pending patent applications and UnitedPhysicians.com—to repetitively generate electronic information and data on and related to individual diagnoses and related chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and practices by said individual physicians and submit said individual physicians' generations to said computer server or servers using said devices and the Internet and, enabled by the Stored Procedures of said SQL Server, to transform said information and data into SQL-created and SQL-generated relational data in said SQL database and/or databases from which further compilations, relations and pooling of said relational data by said SQL Server and said innovative computer programs and software in said computer server or servers are achieved to create and generate the innovative computerized electronic platform of interactive and adaptable pooled consensuses, guidelines and protocols and method by said computer server or servers on providing, improving and optimizing the qualities, quantities, managements and deliveries of health, health-care and health-care services for physicians. Essentially, said methods and systems provided by said pending applications creating, generating and using individual interactive and adaptable related electronic templates for physicians and patients created and generated in a computer server or servers to repetitively create and generate successive generations of versatile individual interactive and adaptable related electronic templates for enabling physicians and patients to generate extensive and comprehensive information and data on and related to health, health-care and health-care services on and related to patients by physicians and patients whose results, consequences and benefits are to save time and human resources and improve the quality of health, health-care and health-care services for all people using said inventions and to insert said information and data into SQL-created and SQL-generated relational information and data in the SQL database and/or databases from which further compilations, relations and pooling of said relational information and data by said SQL Server and said innovative computer programs and software in said computer server or servers are achieved and, using said compilations, relations and pooling, to create and generate the innovative computerized electronic platform of interactive and adaptable pooled consensuses, guidelines and protocols comprising said compilations, relations and pooling which are adaptable and can be edited, updated, expanded, improved and managed by physicians and said computer server or servers in said network or networks of computer servers and devices.

Said individual physicians' submissions are enabled by a plurality of first individual interactive and adaptable related electronic templates as taught in said pending patent applications. In addition, briefly herein although detailed in said pending patent applications, said information and data including words and terms on or relating to health care and health-care services are generated, submitted, stored, related, compiled or pooled in the database and/or databases in and manage by said SQL server and are retrieved—using computer mice, keyboards, physicians' or patients' fingers on the touch-enabled viewing screens and/or voice-activation and the like—by and displayed to physicians and patients as numerous interactive pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services use by physicians of about 85 medical and surgical specialties and practices. Moreover, interactive graphics such as, but not limited to, U.S. Pat. No. 6,132,218 entitled Images for communication of medical information in computer granted Oct. 17, 2000 which can be clicked to present pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services use by physicians of about 85 medical and surgical specialties and practices viewable and useable by said physicians and/or patients. Furthermore, in the preferred embodiments of said patent applications and the present invention, said word and term headers comprise Diagnosis, Evaluation, Chief Complaint, Review of Systems, Physical Examination, Infectious Diseases, Differential Diagnosis, Laboratories such as, but not limited to, Imaging, Body Fluid Tests and Tissues Examination, Assessment and Plan, Medications, Treatment, Surgery, Recommendations, Guidelines, Referral and Follow-up wherein said information and data including said words and terms are found and/or related.

Said processes leading to the generations and retrievals of numerous interactive pop-ups and/or drop-down lists and/or menus and interactive graphics are used in interactive electronic templates for clicking and/or selecting and generating and submitting said information and data including words and terms already related, compiled and stored in the database and/or databases in said SQL Server wherein said information and data including said words and terms are retrieved and used—and less keyboarding and therefore less potential errors and more consistent information and data being generated/used and submitted—by physicians to achieve the goals and objectives of the present invention. At least Java Script and AJAX are used to support interactive pop-ups and/or drop-down lists and/or menus and interactive graphics and interactive □ boxes.

Therefore, any and all physicians in and of about 85 medical and surgical specialties or practices using said devices from diverse and different locations access said computer server or servers via the Internet can retrieve said interactive and adaptable related electronic templates to generate and/or use and submit said information and data including words and terms including numerics and alphanumerics on or relating to diagnoses of diseases and disorders and related information and data on health and health-care. However, among said preferred embodiments of said pending patent applications and the present invention is a preferred embodiment wherein physicians still have the option of keyboarding to generate said information and data including said words and terms.

In said computer server or servers enabled and effected by said innovative computer programs and software and said SQL Server or the like or equivalent programs or software, compiled, related and pooled relational data in said SQL database and/or databases are created and generated by said SQL server from compiling, relating and pooling all said individual physicians' submissions of individual diagnoses and related chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and practices repetitively generated by individual physicians and, enabled by the Stored Procedures of a SQL Server, submitted to and compiled, related and pooled relational information and data in said SQL database and/or databases in said computer server or servers.

Furthermore, effecting the preferred embodiments of the present invention, the present invention provides that there are no redundant duplicates or repeats, doubles in individual compilations and pools of related relational data related to individual diagnoses, individual syndromes and diagnoses or syndromes in individual groups of diagnoses or syndromes—not existed prior to said pending patent applications and not heretofore existed in said individual or any other physicians' submissions—in said compiled, related and pooled relational information and data in said SQL database and/or databases in and managed by said SQL Server in said computer server or servers.

One of the preferred embodiments of the present invention—as taught in said pending patent applications—is said computer server or servers enabled by said computer programs and software to computer-automatically scan and check for redundant duplicates, repeats, doubles or similars of or representing chief complaints, differential diagnoses, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations related to said diagnoses and syndromes in said individual physicians' submissions comprises a process for computer-automatically, repetitively and constantly scanning and checking said individual physicians' submissions with same as, similar to and/or equivalent information and data comprising words and terms in said SQL database and/or databases for redundant duplicates, repeats, doubles or similars effected by said innovative computer programs and software operating in said computer server or servers. The redundant duplicates or repeats, doubles relating to individual diagnoses or syndromes are removed from said relational information and data in said SQL database and/or databases and/or are not inserted into said relational information and data in said SQL database and/or databases so that individual diagnoses, individual syndromes and diagnoses or syndromes in individual groups of diagnoses or syndromes and related relational information and data comprise no redundant duplicates, repeats, doubles or similars which appear so in said consensuses, guidelines and protocols.

In other words, said relational information and data in said interactive and adaptable consensuses, guidelines and protocols and interactive and adaptable related electronic templates comprise no redundant duplicates, doubles and repeats related to said individual diagnoses, individual syndromes and diagnoses or syndromes in individual groups of diagnoses or syndromes upon being repetitively retrieved, viewed and used by any physicians.

In other words, each and every physician neither know nor capable to know what are the individual information and data related to individual diagnoses or syndromes generated and submitted by any other physicians. Therefore, it is only feasible by the functioning of said computer server or servers and said computer programs and software and vital to computer-automatically, repetitively and constantly scan, check and remove said redundant duplicates, repeats, doubles or similars deriving from any and all physicians' submissions—in the order of thousands or millions per annum—on and related to individual diagnoses being submitted by any and all physicians to said SQL database and/or databases in the process for creating and generating said individual interactive and adaptable pooled consensuses and said individual interactive and adaptable pooled guidelines and protocols in and by said computer server or servers in order to achieve the goals and objectives of the present invention.

In other words yet, said innovation applied in and to the present invention enabled and effect the system and processes and the objectives and goals of the present invention as said thousands and millions of individual physicians' submissions mostly with repetitive duplicates, repeats, doubles or similars of words and terms in said information and data on and related to said categories and heading related to individual diagnoses are and will be generated and submitted in said thousands and millions of individual physicians' submissions per annum to said adaptable, updating and expanding related relational information and data in said expanding SQL database and/or databases in said SQL database and/or databases. Having described the preferred embodiments of the present invention supra and infra and earlier in said pending patent applications, the positively vital outcomes of said innovative process for computer-automatically, repetitively and constantly scanning, checking and removing of said thousands and millions of individual physicians' submissions related to individual diagnoses and related said information and data health, health-care and health-care services per annum plus the products such as, but not limited to, the creations and generations of diagnoses or syndromes in individual diagnoses or syndromes and related as the ongoing and even more computer-automatically, repetitively and constantly relating, compiling and pooling relational information and data—and, conversely, the impotence and failure of the present invention to achieve the goals and objectives of the present invention due to the accumulations of massive clogging or obstructive redundances in said relational information and data without said process alone—can be easily comprehended.

Consequently, further to supra, the present invention provides for creating and generating said individual interactive and adaptable pooled consensuses and said individual interactive and adaptable pooled guidelines and protocols in and by said computer server or servers comprising said individual compilations and pools of related relational information and data on individual diagnoses, individual syndromes and diagnoses or syndromes in individual groups of diagnoses or syndromes affecting organs, parts and anatomical sites of humans and related diseases, disorders, chief complaints, differential diagnoses, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and/or practices in said SQL database and/or databases. Individual words and terms representing said individual diagnoses, individual syndromes and diagnoses or syndromes in individual groups of diagnoses or syndromes affecting organs, parts and anatomical sites of humans and related diseases, disorders, chief complaints, differential diagnoses, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and/or practices are represented by individual keys such as, but not limited to primary keys, foreign keys and surrogate keys in said relational information and data in said SQL database and/or databases. The process for creating and generating said individual interactive and adaptable pooled consensuses and said individual interactive and adaptable pooled guidelines and protocols in and by said computer server or servers comprises a process for relating said individual primary, foreign and surrogate keys in said relational information and dat and compiling and pooling said related keys in said SQL database and/or databases in and manage by said SQL Server whose outcomes and related relational information and data comprising categories or headings in said specialties or practices—see examples infra—are retrieved, displayed, viewed on said viewing screens and used as individual interactive, adaptable and expandable second electronic templates.

The present invention further provides a process for editing, updating, expanding and improving said relational information and data in said consensuses, guidelines and protocols by physicians comprises a process for repetitively editing, updating, expanding and improving said relational information and data in said SQL database and/or databases by repetitively retrieving, viewing on said viewing screens and using said plurality of first individual interactive and adaptable related electronic templates by individual physicians to generate and submit individual physicians' submissions to edit, update, expand and improve said relational information and data in said SQL database and/or databases in and manage by said SQL Server. Further more, it is again vital that the present invention provides a process for editing, updating, expanding and improving said relational information and data in said consensuses, guidelines and protocols by said computer server or servers repetitively editing, updating, expanding and improving said relational information and data by said computer server or servers compiling, relating and pooling individual physicians' submissions generated and submitted into said SQL database and/or databases in and manage by said SQL server in said computer server or servers. These features and processes are enabled and effected by said innovative computer programs and software and said SQL server operating in said computer server or servers and/or virtual servers.

Said innovative generations, submissions, processing and transformations of said individual words and terms in said thousands—millions of individual physicians' submissions per annum into said SQL database and/or databases in and manage by said SQL Server in said computer server or servers and said compilations and pooling of relations of said transformed relational information and data in said SQL database and/or databases in and manage by said SQL Server created and generated in and by said computer server or servers enabled and effected by said innovative computer programs and software created and generated said consensuses, guidelines and protocols and plurality of interactive and adaptable electronic templates for achieving the goals and objectives of the present invention.

Consequently, the present invention provides the creations and generations of a computerized electronic platform comprising interactive and adaptable pooled consensuses, guidelines and protocols comprising said adaptable and expandable compiled, related and pooled relational information and data in said SQL database and/or databases in and manage by said SQL server in said computer server or servers comprises compiled, related and pooled relational information and data in said SQL database and/or databases comprising SQL-compiled and -pooled and -related individual diagnoses, individual syndromes and diagnoses in individual groups of diagnoses affecting organs, parts and anatomical sites of humans and related chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and/or practices repetitively generated by physicians and submitted to said computer server or servers wherein said submissions are compiled, related and pooled in said relational data in said SQL database and/or databases in and manage by said SQL Server in said computer server or servers.

It is only feasible by the functioning of said computer server or servers and said computer programs and software and vital to computer-automatically, repetitively and constantly scan, check and remove said redundant duplicates, repeats, doubles or similars deriving from any and all said physicians' submissions on and related to individual diagnoses being submitted by any and all physicians to said SQL database and/or databases in the process for creating and generating said individual interactive and adaptable pooled consensuses and said individual interactive and adaptable pooled guidelines and protocols in and by said computer server or servers in order to achieve the goals and objectives of the present invention.

Present in the consensuses, guidelines and protocols infra are numerous interactive pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services and categories or headings use by physicians of about 85 medical and surgical specialties and practices and interactive graphics such as, but not limited to, U.S. Pat. No. 6,132,218 which can be clicked to present pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services and categories or headings use by physicians of about 85 medical and surgical specialties and practices viewable and useable by physicians and patients.

Further to supra, said interactive and adaptable consensuses, guidelines and protocols, electronic templates and all interactive and adaptable information and data stated herein are supported and enabled by at least Visual Studio and .Net, computer scripting languages, Java script, AJAX, HTML, XHTML and said innovative computer programs and software in said computer server or servers and as taught in said pending patent applicantions.

Furthermore, as taught in pending patent application Ser. No. 12/592,714 entitled Health-care Exchange IV filed Dec. 2, 2009, it is to be noted herein also that the present invention repeat one preferred embodiment of said invention wherein a process for locating or positioning—wherever feasible, achievable, workable or practicable—interactive functions, panels and tools and information and data health, health-care, health-care services and communications in said consensuses, guidelines and protocols and interactive and adaptable electronic templates to physicians and patients in the right half or area of said viewing screens including touch-enabled screens or touchscreens of said devices.

### On Interactive and Adaptable Consensuses

First, a following description represents one of the preferred embodiments of said interactive and adaptable pooled consensuses comprising said adaptable and expandable compiled, related and pooled relational information and data relating to individual diagnoses, individual syndromes and diagnoses or syndromes in individual groups of diagnoses or syndromes in said SQL database and/or databases of the present invention retrieved, displayed and viewed in interactive and adaptable related electronic templates as taught in said pending patent applications.

Some of the preferred embodiments of the present invention are taught by said pending patent applications including application Ser. No. 12/658,112 entitled A system and method for computer-generations of diagnoses filed Feb. 3, 2010 and application Ser. No. 12/655,748 entitled the Artificial-intelligent system and method for managing health-care filed Jan. 7, 2010. However, the present invention teaches the applications and uses of said consensuses, guidelines and protocols in and by said computer server or servers, physicians and patients in said network or networks computer-deducing individual diagnoses of diseases, disorders, individual syndromes or diagnoses or syndromes in individual groups of diagnoses or syndromes affecting organs, parts and anatomical sites of humans to expedite, facilitate, optimize and congruently or uniformly effect the processes for medical-decision making and managing diseases, disorders, health, health-care and health-care services by any or all physicians using this one preferred embodiment comprising said compiled, related and pooled related relational information and data in said SQL database and/or databases in and manage by said SQL Server in said computer server or servers. In said compiled, related and pooled related relational information and data, created and generated in and by said computer server or servers are hundreds of thousands—millions of keys such as, but not limited to, primary keys, foreign keys and surrogate keys in said relational information and data representing words and terms representing individual diagnoses, individual syndromes and related to chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and practices in about 85 medical and surgical specialties and practices in said SQL database and/or databases. Said compilations, relations and pools of said keys enabled and effected by said innovative computer programs and software are created and generated to compilations, relations and pools of keys on said words and terms in said about 85 medical and surgical specialties and practices in said SQL database and/or databases.

In other words, as described supra, said words and terms used by physicians in about 85 medical and surgical specialties and practices are compiled, pools and related in said relational information and data.

Said compilations, relations and pools of said keys enabled and effected by said innovative computer programs and software are created and generated to compilations, relations and pools of keys on said words and terms in said

As taught in said pending patent applications, said individual consensuses—either related, unrelated or not related to individual or more than one medical or surgical specialties—as one of the preferred embodiments of the present invention, are used as individual interactive and adaptive second electronic templates comprising numerous interactive and adaptable pop-ups and/or drop-down lists and/or menus and interactive graphics are used in interactive electronic templates for clicking and/or selecting and generating and submitting said information and data including words and terms already related, compiled and stored in the database and/or databases in said SQL Server wherein said information and data including said words and terms are retrieved and used—and less keyboarding and therefore less potential errors and more consistent information and data being generated/used and submitted—by physicians to achieve the goals and objectives of the present invention. At least Java Script and AJAX are used to support interactive pop-ups and/or drop-down lists and/or menus and interactive graphics and interactive □ boxes. In said pop-ups and/or drop-down lists and/or menus and interactive graphics, individual diagnoses, related and keyed chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and/or practices representing said compilations, relations and pools of said relational information and data related—by said keys and the like in said SQL database and/or databases—to individual diagnoses, individual syndromes or diagnoses or syndromes in individual groups of diagnoses or syndromes—which are known, unknown or to be deduced and shown to physicians or patients by said computer server or servers infra—to physicians or patients—in said SQL database and/or databases in and manage by said SQL Server in said computer server or servers are retrieved, displayed and used by individual or groups of physicians or patients using said devices and the Internet.

Therefore, individual or individual groups of physicians or patients viewing and using said consensuses as said templates comprising said interactive pop-ups and/or drop-down lists and/or menus and interactive graphics and interactive □ boxes comprising related and keyed chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and/or practices related to individual diagnoses, individual syndromes or diagnoses or syndromes in individual groups of diagnoses or syndromes in said compiled, related and pooled relational information and data. In said settings, representing one of the preferred embodiments, said individual or groups of physicians or patients click, select or choose as many appropriate interactive □ boxes or the like, for example, individual keyed chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations in said individual templates and submit said choices or selects to said computer server or servers wherein said innovative computer programs and software cause said computer server or servers to deduce and show on said viewing screens individual diagnoses, individual syndromes or diagnoses or syndromes in individual groups of diagnoses or syndromes related to said choices or selections to said physicians or patients to expedite, facilitate, optimize and congruently or uniformly effect the processes for medical-decision making and managing diseases, disorders, health, health-care and health-care services with immense social, financial and health and well-being benefits for supra.

Infra is the most simplistic and basic representation of one of the preferred embodiments of said individual consensuses whose applications and uses, in real circumstances and settings of applications as provided by the present invention and said pending patent applications, are as vast and complex as hundreds or thousands of real computer-server-created and computer-server-generated interactive and adaptable pooled consensuses which are being retrieved, displayed, used and managed as described infra by physicians and said computer servers in said network or networks of computer servers and devices. Said consensuses are further improved and become more intelligent in better or best computer servers and devices and people involve and will be involved in said network or networks.

First example, as taught in the application Ser. No. 12/655,748 entitled the Artificial-intelligent system and method for managing health-care filed Jan. 7, 2010, an individual such as a physician or a patient activate a query box in said drop-down in said individual related templates related to the Chief Complaints—most commonly, numerous words and terms and related qualifying words, terms and adjectives such as, but not limited to, severity, temporal factors related to individual diagnoses of diseases and disorders—which are entered into said query box. In reality, more words and terms on and related to chief complaints are query applied by physicians or patients in said query box and the like to initially, at and beginning with the chief complaints, enable said computer server or servers to narrow down the diagnoses or even review, search, deduce, reveal and display the diagnoses or diagnosis to the physicians or patients. In this representative illustration, however, only one word and two terms infra—being used here merely to represent said compiled, related and pooled related relational information and data wherein individual words and terms are represented by individual keys—and related to a diagnosis Chlamydia Psittacosis represented by at least one key in said relational data. Said Chlamydia Psittacosis—not known to said physician or patient and will be deduced by said computer server or servers as a representative and simplistic consensus comprising individual interactive and adaptable related electronic templates are being used by said physician or patient to query the diagnosis by entering the following chief complaints—with or without accompanying qualifying words, terms and adjectives—into said query box as follows:
megacolon Central America abdominal pain
   and effected by AJAX and Java Script or after submission said query into and processed by and in said computer server or servers, said one word and two terms will retrieve from said relational information and data, reveal and display on said viewing screen or viewing screens related diagnosis and the remaining interactive and adaptable chief complaints (etc. infra represents more words and terms in related categories or headings) and related relational information and data in said categories or headings related to said diagnosis as follows:
DIAGNOSIS American Trypanosomiasis

abdominal pain megacolon megaesophagus dysphagia odynophagia chronic gastritis peptic ulcer flank pain chest pain regurgitation chronic constipation colonic obstruction volvulus septicemia weight loss etc.
interactive and adaptable American trypanosomiasis-related symptoms and signs
interactive and adaptable American trypanosomiasis-related differential diagnoses
interactive and adaptable American trypanosomiasis-related reviews of systems
interactive and adaptable American trypanosomiasis-related physical examinations
interactive and adaptable American trypanosomiasis-related laboratories, imaging, body fluid tests and tissues examinations
interactive and adaptable American trypanosomiasis-related organs and anatomical sites
interactive and adaptable American trypanosomiasis-related travel histories
interactive and adaptable American trypanosomiasis-related physiology
interactive and adaptable American trypanosomiasis-related microbiology
interactive and adaptable American trypanosomiasis-related epidemiology
interactive and adaptable American trypanosomiasis-related immunizations
interactive and adaptable American trypanosomiasis-related treatments
interactive and adaptable American trypanosomiasis-related procedures
interactive and adaptable American trypanosomiasis-related medications, drugs and therapeutics and effects and side-effects on human organs and bodies of said medications, drugs and therapeutics
interactive and adaptable American trypanosomiasis-related guidelines of managements
interactive and adaptable American trypanosomiasis-related protocols of managements
interactive and adaptable American trypanosomiasis-related recommendations for managements
interactive and adaptable American trypanosomiasis-related referrals to physicians' specialties and practices
   without further application of related information and data in related categories or headings as shown infra such as, but not limited to, related interactive and adaptable chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals and recommendations and physicians' specialties and/or practices in said relational information in said consensus. Furthermore, although not shown supra, in addition to said related interactive and adaptable chief complaints, symptoms and signs and all interactive and adaptable related information and data on differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals and recommendations and physicians' specialties and/or practices related to diagnosis Chlamydia Psittacosis are also retrieved, revealed by said computer server or servers and displayed on said viewing screen or viewing screens of said devices. Said interactive and adaptable interactive and adaptable chief complaints, symptoms and signs and all interactive and adaptable related information and data on differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals and recommendations and physicians' specialties and/or practices are without redundant duplicates, doubles and repeats henceforth WoRDR as shown in two stances infra.

Second example, to further expand on said description, represents slightly more complex albeit still most simplistic representation, said process can be repeated by querying said computer server or server to deduce a diagnosis Chlamydia Psittacosis—the diagnosis not known to said physician or patient—and will be deduced by said computer server or servers after a physician, patient, physicians or patients by entering into said query box and the like and submit or AJAX reveals:
fever chills headaches

1. DIAGNOSIS Brucellosis
fever cough chills headaches etc.
interactive and adaptable brucellosis-related symptoms and signs WoRDR
interactive and adaptable brucellosis-related differential diagnoses WoRDR
interactive and adaptable brucellosis-related reviews of systems WoRDR
interactive and adaptable brucellosis-related physical examinations WoRDR
interactive and adaptable brucellosis-related laboratories, imaging, body fluid tests and tissues examinations WoRDR
interactive and adaptable brucellosis-related organs and anatomical sites WoRDR
interactive and adaptable brucellosis-related travel histories WoRDR
interactive and adaptable brucellosis-related anatomical sites and body parts WoRDR
interactive and adaptable brucellosis-related physiology WoRDR
interactive and adaptable brucellosis-related microbiology WoRDR
interactive and adaptable brucellosis-related epidemiology WoRDR
interactive and adaptable brucellosis-related immunizations WoRDR
interactive and adaptable brucellosis-related treatments WoRDR
interactive and adaptable brucellosis-related procedures WoRDR
interactive and adaptable brucellosis-related medications, drugs and therapeutics and effects and side-effects on human organs and bodies of said medications, drugs and therapeutics WoRDR
interactive and adaptable brucellosis-related guidelines of managements WoRDR
interactive and adaptable brucellosis-related protocols of managements WoRDR
interactive and adaptable brucellosis-related recommendations for managements WoRDR
interactive and adaptable brucellosis-related referrals to physicians' specialties and practices WoRDR

2. DIAGNOSIS Brain Abscess
nuchal rigidity fever cough chills headaches etc.
interactive and adaptable brain abscess-related symptoms and signs
interactive and adaptable brain abscess-related differential diagnoses
interactive and adaptable brain abscess-related reviews of systems
interactive and adaptable brain abscess-related physical examinations
interactive and adaptable brain abscess-related laboratories, imaging, body fluid tests and tissues examinations
interactive and adaptable brain abscess-related organs and anatomical sites
interactive and adaptable brain abscess-related travel histories
interactive and adaptable brain abscess-related anatomical sites and body parts
interactive and adaptable brain abscess-related physiology
interactive and adaptable brain abscess-related microbiology
interactive and adaptable brain abscess-related epidemiology
interactive and adaptable brain abscess-related immunizations
interactive and adaptable brain abscess-related treatments
interactive and adaptable brain abscess-related procedures
interactive and adaptable brain abscess-related medications, drugs and therapeutics and effects and side-effects on human organs and bodies of said medications, drugs and therapeutics
interactive and adaptable brain abscess-related guidelines of managements
interactive and adaptable brain abscess-related protocols of managements
interactive and adaptable brain abscess-related recommendations for managements
interactive and adaptable brain abscess-related referrals to physicians' specialties and practices

3. DIAGNOSIS Chlamydia Psittacosis
Horder's spots fever cough chills headaches etc.
interactive and adaptable chlamydia psittacosis-related symptoms and signs
interactive and adaptable chlamydia-psittacosis-related differential diagnoses
interactive and adaptable chlamydia-psittacosis-related reviews of systems
interactive and adaptable chlamydia-psittacosis-related physical examinations
interactive and adaptable chlamydia-psittacosis-related laboratories, imaging, body fluid tests and tissues examinations
interactive and adaptable chlamydia-psittacosis-related organs and anatomical sites
interactive and adaptable chlamydia-psittacosis-related travel histories
interactive and adaptable chlamydia-psittacosis-related anatomical sites and body parts
interactive and adaptable chlamydia-psittacosis-related physiology
interactive and adaptable brain abscess-related microbiology
interactive and adaptable brain abscess-related epidemiology
interactive and adaptable chlamydia-psittacosis-related immunizations
interactive and adaptable chlamydia-psittacosis-related treatments
interactive and adaptable chlamydia-psittacosis-related procedures
interactive and adaptable chlamydia-psittacosis-related medications, drugs and therapeutics and effects and side-effects on human organs and bodies of said medications, drugs and therapeutics
interactive and adaptable chlamydia-psittacosis-related guidelines of managements
interactive and adaptable chlamydia-psittacosis-related protocols of managements
interactive and adaptable chlamydia-psittacosis-related recommendations for managements
interactive and adaptable chlamydia-psittacosis-related referrals to physicians' specialties and practices

4. DIAGNOSIS Oroya Fever
fever chills headaches etc.
interactive and adaptable Oroya-Fever-related symptoms and signs
interactive and adaptable Oroya-Fever-related differential diagnoses
interactive and adaptable Oroya-Fever-related reviews of systems
interactive and adaptable Oroya-Fever-related physical examinations
interactive and adaptable Oroya-Fever-related laboratories, imaging, body fluid tests and tissues examinations
interactive and adaptable Oroya-Fever-related organs and anatomical sites
interactive and adaptable Oroya-Fever-related travel histories
interactive and adaptable Oroya-Fever-related anatomical sites and body parts
interactive and adaptable Oroya-Fever-related physiology
interactive and adaptable brain abscess-related microbiology
interactive and adaptable brain abscess-related epidemiology
interactive and adaptable Oroya-Fever-related immunizations
interactive and adaptable Oroya-Fever-related treatments
interactive and adaptable Oroya-Fever-related procedures
interactive and adaptable Oroya-Fever-related medications, drugs and therapeutics and effects and side-effects on human organs and bodies of said medications, drugs and therapeutics
interactive and adaptable Oroya-Fever-related guidelines of managements
interactive and adaptable Oroya-Fever-related protocols of managements
interactive and adaptable Oroya-Fever-related recommendations for managements
interactive and adaptable Oroya-Fever-related referrals to physicians' specialties and practices

Said interactive and adaptable representative three words alone—enabled by AJAX and Java Script—retrieved, revealed from said relational interactive and adaptable information and data in said SQL database and/or databases comprise tens of diagnoses and related information and data in said categories or headings supra such as, but not limited to, four representative Brucellosis cough, Brain Abscess nuchal rigidity, chlamydia psittacosis Horder's spots and Oroya Fever and displayed on said viewing screen or screens to said physician, patient, physicians or patients.

In said most simplistic and basic settings without applications of said relational information and data supra, another interactive word—i.e. Horder's spots—is to be smartly applied by said physician or patient in said query box and the like and computer-deducing and -retrieving, -revealing and -displaying on said viewing screen or screens only the diagnosis chlamydia psittacosis and related interactive and adaptable relational information and data to said physician, patient, physicians or patients to expedite, facilitate, optimize and congruently or uniformly effect the processes for medical-decision making and managing diseases, disorders, health, health-care and health-care services by physician, physicians or patients and to insert information and data on health, health-care and health-care services provided to patients by said physician or physicians into relational information and data on said patients in said SQL database and/or databases:
fever chills headaches Horder's spots

DIAGNOSIS Chlamydia Psittacosis
Horder's spots fever cough chills headaches etc.
interactive and adaptable chlamydia-psittacosis-related symptoms and signs
interactive and adaptable chlamydia-psittacosis-related differential diagnoses
interactive and adaptable chlamydia-psittacosis-related reviews of systems
interactive and adaptable chlamydia-psittacosis-related physical examinations
interactive and adaptable chlamydia-psittacosis-related laboratories, imaging, body fluid tests and tissues examinations
interactive and adaptable chlamydia-psittacosis-related organs and anatomical sites
interactive and adaptable chlamydia-psittacosis-related travel histories
interactive and adaptable chlamydia-psittacosis-related anatomical sites and body parts
interactive and adaptable chlamydia-psittacosis-related physiology
interactive and adaptable chlamydia-psittacosis-related microbiology
interactive and adaptable chlamydia-psittacosis-related epidemiology
interactive and adaptable chlamydia-psittacosis-related immunizations
interactive and adaptable chlamydia-psittacosis-related treatments
interactive and adaptable chlamydia-psittacosis-related procedures
interactive and adaptable chlamydia-psittacosis-related medications, drugs and therapeutics and effects and side-effects on human organs and bodies of said medications, drugs and therapeutics
interactive and adaptable chlamydia-psittacosis-related guidelines of managements
interactive and adaptable chlamydia-psittacosis-related protocols of managements
interactive and adaptable chlamydia-psittacosis-related recommendations for managements
interactive and adaptable chlamydia-psittacosis-related referrals to physicians' specialties and practices

Said words in the category of Chief Complaints and other words and terms in said categories and related said categories related to diagnoses, syndromes and groups of diagnoses and/or syndromes in said compiled, related and pooled related relational information and data in said SQL database and/or databases which compose said individual consensuses simplistically represented by said abbreviated consensus.

The reality is computer-deducing diagnoses and syndromes on diseases and disorders are complex to achieve as stated supra and require more steps than those representatively and schematically taken supra. The present invention provides the consensuses comprise of the system and method described herein for overcoming said complexity and difficult to achieve the goals and objectives of the present invention. Therefore, further to supra, in said relational information and data, related to said diagnoses of diseases and disorders represented by individual unique keys are related chief complaints, symptoms and signs, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals and recommendations and physicians' specialties and practices whose words and terms are represented by individual keys related to said diagnoses of diseases and disorders represented by said individual unique keys in said relational information and data in said SQL database and/or databases. Said relations of keys in said relational information and data in said database and/or databases are implemented in individual consensuses comprising said compiled, related and pooled related relational information and data related to, in this case, all said tens of diagnoses represented by said four sample diagnoses and related interactive and adaptable chief complaints, symptoms and signs, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals and recommendations and physicians' specialties and/or practices retrievable, displayed as interactive and adaptable related electronic templates on viewing screens and used by physician, physicians or patients supra.

However, in said relational information and data, related to said diagnoses of diseases and disorders represented by individual unique keys are chief complaints, symptoms and signs, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals and recommendations and physicians' specialties and/or practices whose words and terms are represented by individual unique keys and said individual consensus comprising compiled, related and pooled related relational information and data related to all said tens of diagnoses will retrieve and display said chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals and recommendations and physicians' specialties and/or practices from said compiled, related and pooled related relational information and data in interactive and adaptable electronic template or related templates. By using and submitting said compiled, related and pooled related relational information and data in said templates as taught in said pending patent applications, said computer server or servers can retrieve and display the diagnosis Malaria to said physician or patient.

Moreover, adjectives and variables such as, but not limited to, anatomical sidedness such as left, right, bilateral, ipsilateral, deep, superficial, etc., temporal such as acute, subacute, chronic and the durations or lengths of the chief complaints or symptoms, etc., and severity factors such as various pain scales, etc., to modify said words and terms in said categories or headings are used and present in said SQL database and/or databases to enable and assist said computer server or servers with said computer-deductions of diagnoses, syndromes and diagnoses or syndromes in individual groups of diagnoses and/or syndromes from said consensuses being used by individual physicians, individual patients or individual groups of physicians and patient.

Therefore, using said four diagnoses and said interactive and adaptable information and data as a representation of said system and processes, as taught in said pending applications, by choosing and clicking (or keyboarding, etc.), said interactive words and terms in said diagnosis-related chief complaints without redundant duplicates, doubles and repeats, diagnosis-related symptoms and signs without redundant duplicates, doubles and repeats, diagnosis-related anatomical sites without redundant duplicates, doubles and repeats, diagnosis-related reviews of systems without redundant duplicates, doubles and repeats, diagnosis-related physical examinations without redundant duplicates, doubles and repeats and diagnosis-related laboratories including imaging, body fluids and tissues tests, diagnosis-related family histories without redundant duplicates, doubles and repeats, diagnosis-related physiology without redundant duplicates, doubles and repeats, diagnosis-related genetics without redundant duplicates, doubles and repeats, diagnosis-related immunizations without redundant duplicates, doubles and repeats, diagnosis-related treatments without redundant duplicates, doubles and repeats, diagnosis-related surgeries without redundant duplicates, doubles and repeats, diagnosis-related procedures without redundant duplicates, doubles and repeats, diagnosis-related medications without redundant duplicates, doubles and repeats, drugs and therapeutics and effects and side-effects on human organs and bodies of said medications, drugs and therapeutics without redundant duplicates, doubles and repeats, diagnosis-related guidelines without redundant duplicates, doubles and repeats, diagnosis-related protocols without redundant duplicates, doubles and repeats, diagnosis-related referrals without redundant duplicates, doubles and repeats, diagnosis-related recommendations without redundant duplicates, doubles and repeats and/or diagnosis-related physicians' specialties and practices without redundant duplicates, doubles and repeats considered or deemed to represent the pertinent, relevant or vital information and data which are submitted to said computer server or servers for said computer server or servers enabled by said SQL Server and said innovative computer programs and software to computer-deduce one diagnosis from said computer-deduced, computer-revealed and computer-displayed four representative diagnoses from said relational information and data in said SQL database and/or databases in said computer server or servers to computer-deduce one diagnosis which in this case is said DIAGNOSIS chlamydia psittacosis. Therefore, said system and processes are applied and used by and in said computer server or severs or virtual sever or servers to computer-deduce and computer-reveal individual diagnoses and individual syndromes from diagnoses and syndromes on and relating to diseases, disorders and illnesses in all medical and surgical fields and specialties.

Further to supra, another unique feature of the innovation provided by the present invention is the computer-created, computer-generated and computer-deduced or revealed and displayed on said viewing screens diagnoses or syndromes in individual groups of diagnoses or syndromes affecting same or related organs, parts and anatomical sites of humans to physicians and patients. In other words, there are many diseases and disorders related to different diagnoses—commonly and universally baffle, hinder and cause immense pain and suffering and losses in health, health-care and health-care services—afflicting people causing immense pain and suffering among physicians and patients and escalations of health-care costs and socioeconomic losses. Said diseases and disorders affect one, few or several human organs, parts or systems and have many same, similar or overlapped chief complaints, symptoms and signs, differential diagnoses, reviews of systems, physical examinations and findings, etc. which require diverse, different clinical approaches, managements and treatments. However, to diagnose, collect and differential diagnose and reveal said diagnoses or syndromes in said individual groups of diagnoses or syndromes affecting same or related organs, parts and anatomical sites of humans to physicians or patients are extremely challenging, difficult and most commonly and often missed by physicians or patients. However, the present invention provides said pooled consensuses to diagnose, collect and differential diagnose and reveal all diagnoses or syndromes in said individual groups of diagnoses or syndromes affecting same or related organs, parts and anatomical sites of humans to physicians and patients.

Using one simplistic representation of and among hundreds of diseases and disorders affecting a human heart—and all human organs and bodily systems and thousands of diseases and disorders afflicting people—and, in this one simplified description representing a simplistic setting of one of the preferred embodiments of the present invention. As an extension of supra, in reality as in supra, more than three words and one term on and related to chief complaints are query applied by physician, physicians, patient or patients in a query box infra and the like to initially, at and beginning with the chief complaints, enable said computer server or servers to narrow down the diagnoses or even review, search, deduce, reveal and display diagnoses or syndromes in said individual groups of diagnoses or syndromes to said physician, physicians, patient or patients. In this representative illustration, however, only three words and one term infra—being used here merely to represent said compiled, related and pooled relational information and data on cardiomyopathies and compiled, related and pooled relational information and data in said one SQL database without redundant duplicates, repeats or doubles in SQL database and/or databases wherein individual words and terms, as described herein, on and related to said cardiomyopathies are represented by individual keys in said SQL database and/or databases. Enabled by AJAX and Java Script said collection of diagnoses or syndromes in said individual groups of diagnoses or syndromes affecting the heart and related organs, parts and anatomical sites of humans are retrieved, revealed and displayed on said viewing screens and consensuses comprising individual interactive and adaptable related electronic templates are also retrieved, revealed, displayed and used by said physician, physicians, patient or patients as schematically and simplistically represented infra as follows:

chest pain cardiomegaly peripheral edema myocarditis

angina pectoris chest pain cardiomegaly peripheral edema pale cyanotic limbs

myocarditis ventricular enlargement impaired cor function congestive heart failure increased jugular venous pressure small pulse pressure pulmonary rales S3 heart sound

S4 heart sound hepatojugular reflux resting tachycardia arrhythmias emboli

and etc. representing all interactive and adaptable diagnosis-related relational information and data on chief complaints, symptoms and signs in categories or headings infra

1. DIAGNOSIS Dilated Cardiomyopathies

diagnosis-related relational information and data in said categories or headings

2. DIAGNOSIS Adriamycin Cardiomyopathy

diagnosis-related relational information and data in said categories or headings

3. DIAGNOSIS Cocaine Cardiomyopathy

diagnosis-related relational information and data in said categories or headings

4. DIAGNOSIS Cyclophosphamide Cardiomyopathy

diagnosis-related relational information and data in said categories or headings

5. DIAGNOSIS Viral Cardiomyopathy

diagnosis-related relational information and data in said categories or headings

6. DIAGNOSIS Idiopathic Cardiomyopathies

diagnosis-related relational information and data in said categories or headings

7. DIAGNOSIS Bacterial Cardiomyopathy

diagnosis-related relational information and data in said categories or headings

8. DIAGNOSIS Fungal Cardiomyopathy

diagnosis-related relational information and data in said categories or headings

9. DIAGNOSIS Metazoal Cardiomyopathy

diagnosis-related relational information and data in said categories or headings

10. DIAGNOSIS Protozoal Cardiomyopathy

diagnosis-related relational information and data in said categories or headings

11. DIAGNOSIS Rickettsial Cardiomyopathy

diagnosis-related relational information and data in said categories or headings

12. DIAGNOSIS Spirochetal Cardiomyopathy

diagnosis-related relational information and data in said categories or headings

13. DIAGNOSIS Dermatomyositis Cardiomyopathy

diagnosis-related relational information and data in said categories or headings

14. DIAGNOSIS Polyarteritis Nodosa Cardiomyopathy

diagnosis-related relational information and data in said categories or headings

15. DIAGNOSIS Progressive Systemic Cardiomyopathy

diagnosis-related relational information and data in said categories or headings

16. DIAGNOSIS Rheumatoid Arthritis Cardiomyopathy

diagnosis-related relational information and data in said categories or headings

17. DIAGNOSIS Systemic Lupus Erythematous Cardiomyopathy

diagnosis-related relational information and data in said categories or headings

18. DIAGNOSIS Wegener's Granulomatosis Cardiomyopathy

diagnosis-related relational information and data in said categories or headings

19. DIAGNOSIS Antisphospholipid Antibody Syndrome

diagnosis-related relational information and data in said categories or headings

20. DIAGNOSIS Elctrolytes Deficiency Cardiomyopathy

diagnosis-related relational information and data in said categories or headings

21. DIAGNOSIS Familial Storage Cardiomyopathy

diagnosis-related relational information and data in said categories or headings

22. DIAGNOSIS Fabry's Disease Cardiomyopathy

diagnosis-related relational information and data in said categories or headings

23. DIAGNOSIS Glycogen Storage Disease Cardiomyopathy

diagnosis-related relational information and data in said categories or headings

24. DIAGNOSIS Hematochromatosis Cardiomyopathy

diagnosis-related relational information and data in said categories or headings

25. DIAGNOSIS Mucopolysaccharidoses Cardiomyopathy

diagnosis-related relational information and data in said categories or headings

26. DIAGNOSIS Amyloidosis Cardiomyopathy

diagnosis-related relational information and data in said categories or headings

27. DIAGNOSIS Secondary Restrictive Cardiomyopathy

diagnosis-related relational information and data in said categories or headings

28. DIAGNOSIS Neoplasms Cardiomyopathy

diagnosis-related relational information and data in said categories or headings

29. DIAGNOSIS Sarcoidosis Cardiomyopathy

diagnosis-related relational information and data in said categories or headings

30. DIAGNOSIS Peripartum Cardiomyopathy

diagnosis-related relational information and data in said categories or headings

31. DIAGNOSIS Postpartum Cardiomyopathy

diagnosis-related relational information and data in said categories or headings

32. DIAGNOSIS Marfan's Syndrome Cardiomyopathy

diagnosis-related relational information and data in said categories or headings

33. DIAGNOSIS Toxins-Caused Cardiomyopathies

diagnosis-related relational information and data in said categories or headings

34. DIAGNOSIS Radiation Cardiomyopathy

diagnosis-related relational information and data in said categories or headings

In said most simplistic and basic settings without applications of said relational information and data in said categories or headings supra, another interactive term which are present in said revealed and displayed interactive and adaptable chief complaints and shown infra—i.e third pregnancy trimester—is to be smartly applied by said physician, physicians, patients or patient in said query box and the like and computer-deducing and -retrieving, -revealing and -displaying on said viewing screen or screens only the diagnosis peripartum cardiomyopathy and related interactive and adaptable relational information and data in said categories or headings to said physician, patient, physicians or patients to expedite, facilitate, optimize and congruently or uniformly effect the processes for medical-decision making and managing diseases, disorders, health, health-care and health-care services by physician, physicians or patients and to insert information and data on health, health-care and health-care services provided to patients by said physician or physicians into relational information and data on said patients in said SQL database and/or databases:
chest pain cardiomegaly peripheral edema myocarditis third pregnancy trimester

angina pectoris chest pain cardiomegaly peripheral edema pale cynotic limbs

myocarditis ventricular enlargement impaired cor function congestive heart failure increased jugular venous pressure small pulse pressure pulmonary rales S3 heart sound

S4 heart sound hepatojugular reflux resting tachycardia arrhythmias emboli

and etc. representing all interactive and adaptable diagnosis-related relational information and data on chief complaints, symptoms and signs in categories or headings infra including third pregnancy trimester

DIAGNOSIS Peripartum Cardiomyopathy
interactive and adaptable peripartum cardiomyopathy-related symptoms and signs WoRDR
interactive and adaptable peripartum cardiomyopathy-related differential
   diagnoses comprise
   amyloidosis cardiomyopathy
   chronic mitral regurgitation
   coronary artery diseases
   constrictive pericarditis
   end-stage aortic valve disease
   hypertensive heart diseases
   infundibular pulmonic stenosis
   physiologic hypertensive heart
   primary mitral valve disease
   subvalvular aortic stenosis
   ventricular septal defect
   pneumonia
interactive and adaptable peripartum cardiomyopathy-related reviews of systems WoRDR
interactive and adaptable peripartum cardiomyopathy-related physical examinations WoRDR
interactive and adaptable peripartum cardiomyopathy-related laboratories, imaging, body fluid tests and tissues examinations WoRDR
interactive and adaptable peripartum cardiomyopathy-related organs and anatomical sites WoRDR
interactive and adaptable peripartum cardiomyopathy-related travel histories WoRDR
interactive and adaptable peripartum cardiomyopathy-related anatomical sites and body parts WoRDR
interactive and adaptable peripartum cardiomyopathy-related physiology WoRDR
interactive and adaptable peripartum cardiomyopathy-related epidemiology WoRDR
interactive and adaptable peripartum cardiomyopathy-related treatments WoRDR
interactive and adaptable peripartum cardiomyopathy-related procedures WoRDR
interactive and adaptable peripartum cardiomyopathy-related medications, drugs and therapeutics and effects and side-effects on human organs and bodies of said medications, drugs and therapeutics WoRDR
interactive and adaptable peripartum cardiomyopathy-related guidelines of managements WoRDR
interactive and adaptable peripartum cardiomyopathy-related protocols of managements WoRDR
interactive and adaptable peripartum cardiomyopathy-related recommendations for managements WoRDR
interactive and adaptable peripartum cardiomyopathy-related referrals to physicians' specialties and practices WoRDR

As described supra, every diagnosis or syndrome in about 85 medical and surgical specialties and practices and related interactive words and terms in said categories or headings on disease, disorder, health, health-care and health-care services are represented by related keys in said compiled, related and pooled relational information and data in said SQL databases in said computer server, servers and/or virtual servers. Furthermore, as described supra, diagnoses or syndromes in individual groups of diagnoses or syndromes and related words and terms in said categories or headings on diseases, disorders, health, health-care and health-care services described herein are represented by related keys as created and generated by said innovative computer programs and software in said computer server, servers and/or virtual servers.

The compilations, relations and pools of relational information and data on diagnoses, syndromes and diagnoses or syndromes in individual groups of diagnoses or syndromes in about 85 medical and surgical specialties and practices and related interactive words and terms in said categories or headings on disease, disorder, health, health-care and health-care services in said SQL database and/or databases comprise hundreds of thousands to millions of words and terms represented by individual primary keys, foreign keys and surrogate keys and the like in said SQL database and/or databases and compilations, relations and pools of said keys are created and generated by and in said computer server, servers and/or virtual servers and said computer programs and software whose products and outcomes are retrieved, viewed and used as individual interactive and adaptable consensuses as numerous—in the order of hundreds, thousands or millions—as repetitively created and generated and improved by and in said computer server, servers and/or virtual servers comprising individual interactive and adaptable related electronic templates in responses to physicians and patients to achieve the goals and objectives of the present invention.

In brief, said computer server, servers and/or virtual servers enabled by said innovative computer programs and software to analyze, compare and scan relational information and data on any and all diagnoses, syndromes and related diagnoses or syndromes in individual groups of diagnoses and/or syndromes and related said categories or headings in all medical and surgical specialties and practices in said computer server, servers and/or virtual servers.

Said process and outcome, as described supra, are effected by AJAX and Java Script or after submission said query into and processed by and in said computer server or servers, said one word and two terms will retrieve from said relational information and data, reveal and display on said viewing screen or viewing screens related diagnosis and the remaining interactive and adaptable chief complaints (etc. infra represents more interactive words and terms in related categories or headings) and interactive and adaptable diagnosis-related relational information and data in said categories or headings comprising interactive words and terms without redundant duplicates, doubles or repeats related to said diagnoses or syndromes as used and shown supra representing one consensuses of and among numerous individual interactive and adaptable consensuses in this case on cardiomyopathies—the order of hundreds or thousands as more derivatives of said consensuses are repetitively created, generated and improved by and in said computer server, servers and/or virtual servers comprising individual interactive and adaptable related electronic templates in responses to physicians and patients.

Said representations including said interactive and adaptable relational information and data on said categories or headings, in its most simplistic order represent a few consensuses representing thousands to millions of computer-created and computer-generated interactive and adaptable consensuses repetitively generated in responses to physicians and patients using the present invention and are repetitively retrieved, viewed on viewing screens and usable by any and all physicians and patients using said devices. This is due to the fact that related to said group of diagnoses related to said cardiomyopathies, as a simplified example, there are numerous other consensuses related to said group of diagnoses relating to which are differential diagnoses such as one said representation comprising interactive and adaptable peripartum cardiomyopathy-related differential diagnoses comprise amyloidosis cardiomyopathy, chronic mitral regurgitation, coronary artery diseases, constrictive pericarditis, end-stage aortic valve disease, hypertensive heart diseases, infundibular pulmonic stenosis, physiologic hypertensive heart, primary mitral valve disease, subvalvular aortic stenosis, ventricular septal defect, pneumonia and all related categories or headings in and related to said numerous other consensuses and all related categories or headings and other related numerous consensuses on or related to other diagnoses and more permutations to create and generate a virtual three-dimensional arrays of computer-created, computer-generated and computer-revealed interactive and adaptable consensuses and related interactive and adaptable guidelines and protocols infra on diagnoses and syndromes on and related to diseases, disorders and illnesses treated and being treated by physicians and doctors in all about 85 medical and surgical specialties or practices in said computer server, servers, virtual server and/or virtual servers. Said virtual three-dimensional arrays comprising computer-created, computer-generated and computer-revealed interactive and adaptable pooled consensuses and said computer-created, computer-generated and computer-revealed interactive and adaptable pooled guidelines and protocols are computer-created, computer-generated and computer-revealed using the system and method taught in and by U.S. Pat. No. 6,132,218 wherein said arrays are used and applied as a three-dimensional coordinate system of arrays of said interactive and adaptable pooled consensuses and said interactive and adaptable pooled guidelines and protocols on the computer-generated interactive human figures and anatomical sites, body parts and organs by and in said computer server, servers, virtual server and/or virtual servers and are displayed, elucidated and viewed in said viewing screens and interactive with and used by physicians and patients as taught supra.

In other words, said U.S. Pat. No. 6,132,218 can support said embodiments and the derivatives of said interactive and adaptable pooled consensuses and said interactive and adaptable pooled guidelines and protocols as pop-up lists and displays of said arrays of said interactive and adaptable pooled consensuses and said interactive and adaptable pooled guidelines and protocols and/or drop-down lists and displays of said arrays of said interactive and adaptable pooled consensuses and said interactive and adaptable pooled guidelines and protocols and/or menus of lists and displays of said arrays of said interactive and adaptable pooled consensuses and said interactive and adaptable pooled guidelines and protocols comprising said relational information and data in said SQL database and/or databases viewable and useable by said physicians of about 85 medical and surgical specialties and practices and/or patients.

As described and further to supra, the reality is computer-deducing diagnoses or syndromes in individual groups of diagnoses or syndromes affecting same and related organs, parts and anatomical sites of humans are much more complex and require even more computational steps than those representatively and schematically taken supra albeit uniquely easiest and electronic-speedily and accurately achieved—than processes performed by said physicians and mental processes in said physicians' brains—in and by said computer server, servers, virtual server and/or virtual servers and said computer programs and software (plural) operating in said computer server, servers, virtual server and/or virtual servers, devices and the Internet.

The present invention provides the consensuses for overcoming said complexity and performing more computational steps for electronic-speedily and accurately achieved computer-deduced and computer-revealed in seconds or minutes which is so very much faster than individual physicians' or groups of physicians' brains.

Therefore, further to said description of one of the preferred embodiments using said first five diagnoses—American trypanosomiasis, brucellosis, brain abscess, chlamydia psittacosis and Oroya fever, in said second 32 diagnoses of cardiomyopathies shown supra are said relational information and data comprising interactive and adaptable diagnosis-related chief complaints, symptoms and signs, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals and recommendations and physicians' specialties and practices whose interactive words and terms are represented by individual keys related to said diagnoses of diseases and disorders represented by said individual unique keys in said relational information and data in said SQL databases. Said relations of keys in said relational information and data in said database and/or databases are implemented in individual consensuses comprising said compiled, related and pooled related relational information and data related to, in this case, all said tens of diagnoses.

Therefore, in said relational information and data, related to said 34 cardiomyopathies are individual unique keys representing diagnosis-related chief complaints, symptoms and signs, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals and recommendations and physicians' specialties and/or practices whose compilations, relations and pools are schematically and present immediately adjacent and inferior to said individual related cardiomyopathies (details are not shown) as diagnosis-related anatomical sites WoRDR, diagnosis-related chief complaints WoRDR, diagnosis-related symptoms and signs WoRDR, diagnosis-related reviews of systems WoRDR, diagnosis-related physical examinations WoRDR and diagnosis-related laboratories including imaging, body fluids and tissues tests WoRDR, diagnosis-related family histories WoRDR, diagnosis-related physiology WoRDR, diagnosis-related genetics WoRDR, diagnosis-related immunizations WoRDR, diagnosis-related treatments WoRDR, diagnosis-related surgeries WoRDR, diagnosis-related procedures WoRDR, diagnosis-related medications WoRDR, drugs and therapeutics and effects and side-effects on human organs and bodies of said medications, drugs and therapeutics WoRDR, diagnosis-related guidelines WoRDR, diagnosis-related protocols WoRDR, diagnosis-related referrals WoRDR, diagnosis-related recommendations WoRDR and diagnosis-related physicians' specialties and practices WoRDR.

Moreover, adjectives and variables such as, but not limited to, anatomical sidedness such as left, right, bilateral, ipsilateral, deep, superficial, etc., temporal such as acute, subacute, chronic and the durations or lengths of the chief complaints or symptoms, etc., and severity factors such as various pain scales, etc., to modify said interactive words and terms in said categories or headings are used and present in said SQL databases to enable and assist said computer server or servers with said computer-deductions of diagnoses, syndromes and diagnoses or syndromes in individual groups of diagnoses and/or syndromes from said consensuses being used by individual physicians, individual patients or individual groups of physicians and patient.

Therefore, using said thirty four diagnoses and said interactive and adaptable information and data WoRDR as a representation of said system and processes, as taught in said pending applications, by choosing and clicking (or keyboarding, etc.), said interactive words and terms in said diagnosis-related anatomical sites WoRDR, diagnosis-related chief complaints WoRDR, diagnosis-related symptoms and signs WoRDR, diagnosis-related reviews of systems WoRDR, diagnosis-related physical examinations WoRDR and diagnosis-related laboratories including imaging, body fluids and tissues tests WoRDR, diagnosis-related family histories WoRDR, diagnosis-related physiology WoRDR, diagnosis-related genetics WoRDR, diagnosis-related immunizations WoRDR, diagnosis-related treatments WoRDR, diagnosis-related surgeries WoRDR, diagnosis-related procedures WoRDR, diagnosis-related medications WoRDR, drugs and therapeutics and effects and side-effects on human organs and bodies of said medications, drugs and therapeutics WoRDR, diagnosis-related guidelines WoRDR, diagnosis-related protocols WoRDR, diagnosis-related referrals WoRDR, diagnosis-related recommendations WoRDR and diagnosis-related physicians' specialties and practices WoRDR considered or deemed to represent the pertinent, relevant or vital information and data which are submitted to said computer server, servers, virtual server and/or virtual servers for said computer server or servers enabled by said SQL Server and said innovative computer programs and software to computer-deduce diagnoses or syndromes in individual groups of diagnoses or syndromes from said computer-deduced, computer-revealed and computer-displayed said thirty four representative diagnoses from said relational information and data in said SQL database and/or databases in said computer server or servers.

Furthermore, said computer server, servers, virtual server and/or virtual servers enabled by said innovative computer programs and software to electronic-speedily and accurately analyze, compare and scan relational information and data and relate and electronic-speedily and accurately compile said relational information and data-related diagnoses or syndromes in individual groups of diagnoses or syndromes affecting same and related organs, parts and anatomical sites of humans in said relational information and data in said compiled, related and pooled SQL database and/or databases and the relational information and data on health, health-care and health-care services of a representative healthy and well—except for the chief complaints infra—30 year old active female patient with no past medical and surgical history including no history of diabetes mellitus, hypertension and normal serum lipid profiles on laboratory tests and uneventful pregnancy up to her present third trimester as recorded in said patient's health and health-care information and data in a relational information and data on said patient in the SQL database to electronic-speedily and accurately retrieve, revealed and displayed on said viewing screens, for example, prioritized differential diagnoses to individual physicians or a group of individual physicians and patient are schematically and briefly represented as follows:
chest pain cardiomegaly peripheral edema myocarditis third pregnancy trimester

angina pectoris chest pain cardiomegaly peripheral edema pale cynotic limbs

myocarditis ventricular enlargement impaired cor function congestive heart failure increased jugular venous pressure small pulse pressure pulmonary rales S3 heart sound

S4 heart sound hepatojugular reflux resting tachycardia arrhythmias emboli

and etc. representing all interactive and adaptable diagnosis-related relational information and data on chief complaints, symptoms and signs in categories or headings infra including third pregnancy trimester

DIAGNOSIS Peripartum Cardiomyopathy
interactive and adaptable peripartum cardiomyopathy-related symptoms and signs WoRDR
interactive and adaptable peripartum cardiomyopathy-related ranked differential diagnoses in a 30 year old active female patient with no past medical and surgical history including no history of diabetes mellitus, hypertension and normal serum lipid profiles on laboratory tests and uneventful pregnancy in a female population of said, similar or equivalent attributes, settings, circumstances and ethnicity in said relational information and data in said SQL database and/or databases:
   amyloidosis cardiomyopathy □ unlikely
   chronic mitral regurgitation □4
   coronary artery diseases □3
   constrictive pericarditis □10
   end-stage aortic valve disease
   hypertensive heart diseases □2
   infundibular pulmonic stenosis □9
   physiologic hypertensive heart □1
   primary mitral valve disease □5
   subvalvular aortic stenosis □8
   ventricular septal defect □6
   pneumonia □7
interactive and adaptable peripartum cardiomyopathy-related reviews of systems WoRDR
interactive and adaptable peripartum cardiomyopathy-related physical examinations WoRDR
interactive and adaptable peripartum cardiomyopathy-related laboratories, imaging, body fluid tests and tissues examinations WoRDR
interactive and adaptable peripartum cardiomyopathy-related organs and anatomical sites WoRDR
interactive and adaptable peripartum cardiomyopathy-related travel histories WoRDR
interactive and adaptable peripartum cardiomyopathy-related anatomical sites and body parts WoRDR
interactive and adaptable peripartum cardiomyopathy-related physiology WoRDR
interactive and adaptable peripartum cardiomyopathy-related epidemiology WoRDR
interactive and adaptable peripartum cardiomyopathy-related treatments WoRDR
interactive and adaptable peripartum cardiomyopathy-related procedures WoRDR
interactive and adaptable peripartum cardiomyopathy-related medications, drugs and therapeutics and effects and side-effects on human organs and bodies of said medications, drugs and therapeutics WoRDR
interactive and adaptable peripartum cardiomyopathy-related guidelines of managements WoRDR
interactive and adaptable peripartum cardiomyopathy-related protocols of managements WoRDR
interactive and adaptable peripartum cardiomyopathy-related recommendations for managements WoRDR
interactive and adaptable peripartum cardiomyopathy-related referrals to physicians' specialties and practices WoRDR
   wherein said representative sequential ranking of □1-□10 and □ unlikely, least likely, not likely, or please refer patient to physician named X or groups of physicians Y, etc. (for example, 1=represents most likely or must investigate and test first to 10=represents the least likely or least need to investigate and test) represents said computational processes and outcomes based on said relational information and data in said SQL database and/or databases. Similarly, said computer said computational processes and outcomes based on said relational information and data in said SQL database and/or databases in said computer server or servers are applied to said interactive and adaptable peripartum cardiomyopathy-related categories or headings representing diseases, disorders and illnesses treated and being treated by physicians and doctors in all about 85 medical and surgical specialties or practices.

Further similarly, said computational processes and outcomes based on said relational information and data in said SQL database and/or databases including SQL databases on information and data on health, health-care and health-care services of individual patients and/or individual patient groups or patient populations, etc., in said computer server or servers are applied to diagnoses or syndromes in individual groups of diagnoses or syndromes and interactive and adaptable diagnosis-related categories or headings for diseases, disorders and illnesses treated and being treated by physicians and doctors in all about 85 medical and surgical specialties or practices.

In brief, said computer server, servers, virtual server or servers enabled by said innovative computer programs and software electronic-speedily and accurately analyze, compare and scan, process and manage relational information and data and electronic-speedily and accurately compile said relational information and data-related diagnoses or syndromes in individual groups of diagnoses or syndromes affecting same and related organs, parts and anatomical sites of humans in said relational information and data in said compiled, related and pooled SQL database and/or databases to electronic-speedily and accurately retrieve, revealed and displayed on said viewing screens to individual physicians, individual patients or patients.

Said uses and applications of said interactive and adaptable pooled consensuses resulted in the repetitive insertions of information and data on said health, health-care and health-care services into relational information and data of patients and, as described in the claims infra and one of the preferred embodiments of the present invention and as taught in said pending patent applications wherein interactive and adaptable related electronic templates are used by physicians and patients, for generating, improving, updating and inserting additional information and data into said compiled, related and pooled relational information and data in said SQL database and/or databases and also into the relational information and data on health, health-care and health-care services comprising no redundant duplicates or repeats, doubles related to in said SQL database and/or databases in and manage by said SQL Server in said computer server or servers for generating, improving, updating and inserting additional data into said compiled, related and pooled relational data in said SQL database and/or databases and in said interactive and adaptable compiled consensuses, guidelines and protocols.

### On Interactive and Adaptable Guidelines and Protocols

Said brief description of one of the preferred embodiments of said consensuses is applicable and used for the compiled guidelines and protocols infra of the present invention. The present invention provides computer-created and computer-generated guidelines and protocols related and linked to said individual compiled consensuses.

First, in one of the preferred embodiments of the present invention and a simplistic representative guidelines and protocols using said consensus on peripartum cardiomyopathy as a representative illustration of a computer-created and computer-generated pooled guideline and protocol on and related to peripartum cardiomyopathy, said interactive and adaptable pooled guideline and protocol on peripartum cardiomyopathy computer-retrieved, computer-revealed and computer-highlighted for representative individual physicians or a group of physicians as applicable to a representative healthy and well—except for the chief complaints infra—40 year old female patient with no past medical and surgical history and uneventful pregnancy up to her present third trimester as recorded in said patient's health and health-care information and data in a relational information and data on said patient in the SQL database are schematically and briefly represented as follows:
chest pain cardiomegaly•peripheral edema myocarditis third pregnancy trimester
DIAGNOSIS Cardiomyopathies
angina pectoris chest pain cardiomegaly peripheral edema pale cynotic limbs

myocarditis ventricular enlargement impaired cor function congestive heart failure increased jugular venous pressure small pulse pressure pulmonary rales S3 heart sound

S4 heart sound hepatojugular reflux resting tachycardia arrhythmias emboli

and etc. representing all interactive and adaptable diagnosis-related relational information and data on chief complaints, symptoms and signs in categories or headings infra including third pregnancy trimester

DIAGNOSIS Peripartum Cardiomyopathy
interactive and adaptable peripartum cardiomyopathy-related symptoms and signs WoRDR □
interactive and adaptable peripartum cardiomyopathy-related differential diagnoses coronary artery diseases □
interactive and adaptable coronary artery diseases-related treatment WoRDR □
interactive and adaptable coronary artery diseases-related procedureWoRDR □
interactive and adaptable coronary artery diseases-related medications, drugs and therapeutics and effects and side-effects on human organs and bodies of said medications, drugs and therapeutics WoRDR □
interactive and adaptable coronary artery diseases-related guidelines of managements WoRDR □
interactive and adaptable coronary artery diseases-related protocols of managements WoRDR □
interactive and adaptable coronary artery diseases-related recommendations for managements WoRDR □
interactive and adaptable coronary artery diseases-related referrals to physicians' specialties and practices WoRDR □
physiologic hypertensive heart □
interactive adaptable physiologic hypertensive heart-related treatment WoRDR □
interactive adaptable physiologic hypertensive heart-related procedureWoRDR □
interactive and adaptable physiologic hypertensive heart-related medications, drugs and therapeutics and effects and side-effects on human organs and bodies of said medications, drugs and therapeutics WoRDR □
interactive and adaptable physiologic hypertensive heart-related guidelines of managements WoRDR □
interactive and adaptable physiologic hypertensive heart-related protocols of managements WoRDR □
interactive and adaptable physiologic hypertensive heart-related recommendations for managements WoRDR □
interactive and adaptable physiologic hypertensive heart-related referrals to physicians' specialties and practices WoRDR □
   interactive and adaptable other peripartum cardiomyopathy-related differential diagnoses
amyloidosis cardiomyopathy
chronic mitral regurgitation
primary mitral valve disease
subvalvular aortic stenosis
ventricular septal defect
pneumonia
constrictive pericarditis
end-stage aortic valve disease
hypertensive heart diseases
infundibular pulmonic stenosis

Therefore, like said related interactive and adaptable pooled consensuses supra, said one simplistic representation of thousands—millions of interactive and adaptable pooled guidelines and protocols computer-created and computer-generated in responses to physicians and patients, said patient's medical history and said query by said representative individual physicians or a group of physicians and/or patient to whom said representative and simplistic guidance and protocol are displayed as interactive and adaptable guideline and protocol schematically represent supra by individual interactive □ boxes—one of the preferred embodiments—computer-retrieved and computer-revealed. In other words, said individual interactive □ boxes to the right of said interactive and adaptable categories or headings—each of which comprises numerous said interactive and adaptable pop-ups and/or drop-down lists and/or menus and interactive graphics and interactive □ boxes comprising related and keyed physical examinations, laboratories, imaging, body fluid tests and tissues examinations, treatments, surgeries, procedures, medications, drugs and therapeutics and effects and side-effects on human organs and bodies of said medications, drugs and therapeutics, referrals, recommendations and physicians' specialties and/or practices—provide a guideline or guidance and a protocol for said individual physicians or a group of physicians and/or patient to use.

Said representative use or uses of said guidance and protocol resulted in the submission and insertion of said information and data on said health, health-care and health-care services into said relational information and data of said patient and, as described in the claims infra and one of the preferred embodiments of the present invention for generating, improving, updating and inserting additional data into said compiled, related and pooled relational data in said SQL database and/or databases, also into the relational information and data on health, health-care and health-care services comprising no redundant duplicates or repeats, doubles related to in said SQL database and/or databases in and manage by said SQL Server in said computer server or servers for generating, improving, updating and inserting additional data into said compiled, related and pooled relational data in said SQL database and/or databases.

With reference to individual diseases and disorders and diseases and disorders in individual groups of diseases and disorders affecting same and related organs, parts and anatomical sites of humans in about 85 medical and surgical specialties and practices, the steps and processes for computer-deducing and computer-generating individual guidelines and protocols for managing and delivery health, health-care and health-care services on and related to individual diseases and disorders and diseases and disorders in individual groups of diseases and disorders affecting same and related organs, parts and anatomical sites of humans are much more complex and require even more computational steps than those representatively and schematically taken supra albeit uniquely easiest and electronic-speedily and accurately achieved—than processes and steps performed by said physicians and mental processes in said physicians' brains—in and by said computer server, servers, virtual server and/or virtual servers and said computer programs and software (plural) operating in said computer server, servers, virtual server and/or virtual servers, devices and the Internet.

Yet another unique and innovative feature of the present invention is, for example, once diagnoses or syndromes in individual groups of diagnoses or syndromes are revealed by said computer-generated consensuses and displayed to individual physicians, patients or individual groups of physicians, the related computer-created and computer-generated guidelines and protocols on the managements and treatments of diseases and/or disorders related to said diagnoses or syndromes in individual groups of diagnoses or syndromes are computer-created, computer-generated and computer-automatically revealed and displayed on said viewing screens to said individual physicians, patients or individual groups of physicians on the viewing screens of said devices and used by said individual physicians, patients or individual groups of physicians. The explanation and logics of the processes and steps of this preferred embodiment has been described supra in said consensuses and do not need to be repeated infra. Thus, the following—representative DIAGNOSIS cardiomyopathies—represents one of the preferred embodiment on said computer-generated interactive and adaptable guidelines and protocols comprising interactive and adaptable information and data in diagnosis-related categories or headings infra comprising interactive words and terms (not shown) and displayed schematically and simplistically represented on said viewing screens as follow:
chest pain cardiomegaly peripheral edema myocarditis

DIAGNOSIS Cardiomyopathies

angina pectoris chest pain cardiomegaly peripheral edema pale cyanotic limbs

myocarditis ventricular enlargement impaired cor function congestive heart failure increased jugular venous pressure small pulse pressure pulmonary rales S3 heart sound

S4 heart sound hepatojugular reflux resting tachycardia arrhythmias emboli

and etc. representing all interactive and adaptable diagnosis-related relational information and data on chief complaints, symptoms and signs in categories or headings infra

1. DIAGNOSIS Dilated Cardiomyopathies

diagnosis-related relational information and data in said categories or headings □n

2. DIAGNOSIS Adriamycin Cardiomyopathy

diagnosis-related relational information and data in said categories or headings □n

3. DIAGNOSIS Cocaine Cardiomyopathy

diagnosis-related relational information and data in said categories or headings □n

4. DIAGNOSIS Cyclophosphamide Cardiomyopathy

diagnosis-related relational information and data in said categories or headings □n

5. DIAGNOSIS Viral Cardiomyopathy

diagnosis-related relational information and data in said categories or headings □n

6. DIAGNOSIS Idiopathic Cardiomyopathies

diagnosis-related relational information and data in said categories or headings □n

7. DIAGNOSIS Bacterial Cardiomyopathy

diagnosis-related relational information and data in said categories or headings □n

8. DIAGNOSIS Fungal Cardiomyopathy

diagnosis-related relational information and data in said categories or headings □n

9. DIAGNOSIS Metazoal Cardiomyopathy

diagnosis-related relational information and data in said categories or headings □n

10. DIAGNOSIS Protozoal Cardiomyopathy

diagnosis-related relational information and data in said categories or headings □n

11. DIAGNOSIS Rickettsial Cardiomyopathy

diagnosis-related relational information and data in said categories or headings □n

12. DIAGNOSIS Spirochetal Cardiomyopathy

diagnosis-related relational information and data in said categories or headings □n

13. DIAGNOSIS Dermatomyositis Cardiomyopathy

diagnosis-related relational information and data in said categories or headings □n

14. DIAGNOSIS Polyarteritis Nodosa Cardiomyopathy

diagnosis-related relational information and data in said categories or headings

15. DIAGNOSIS Progressive Systemic Cardiomyopathy

diagnosis-related relational information and data in said categories or headings □n

16. DIAGNOSIS Rheumatoid Arthritis Cardiomyopathy

diagnosis-related relational information and data in said categories or headings

17. DIAGNOSIS Systemic Lupus Erythematous Cardiomyopathy

diagnosis-related relational information and data in said categories or headings □n

18. DIAGNOSIS Wegener's Granulomatosis Cardiomyopathy

diagnosis-related relational information and data in said categories or headings □n

19. DIAGNOSIS Antisphospholipid Antibody Syndrome

diagnosis-related relational information and data in said categories or headings □n

20. DIAGNOSIS Elctrolytes Deficiency Cardiomyopathy

diagnosis-related relational information and data in said categories or headings □n

21. DIAGNOSIS Familial Storage Cardiomyopathy

diagnosis-related relational information and data in said categories or headings □n

22. DIAGNOSIS Fabry's Disease Cardiomyopathy

diagnosis-related relational information and data in said categories or headings □n

23. DIAGNOSIS Glycogen Storage Disease Cardiomyopathy

diagnosis-related relational information and data in said categories or headings □n

24. DIAGNOSIS Hematochromatosis Cardiomyopathy

diagnosis-related relational information and data in said categories or headings □n

25. DIAGNOSIS Mucopolysaccharidoses Cardiomyopathy

diagnosis-related relational information and data in said categories or headings □n

26. DIAGNOSIS Amyloidosis Cardiomyopathy

diagnosis-related relational information and data in said categories or headings □n

27. DIAGNOSIS Secondary Restrictive Cardiomyopathy

diagnosis-related relational information and data in said categories or headings □n

28. DIAGNOSIS Neoplasms Cardiomyopathy

diagnosis-related relational information and data in said categories or headings □n

29. DIAGNOSIS Sarcoidosis Cardiomyopathy

diagnosis-related relational information and data in said categories or headings □n

30. DIAGNOSIS Peripartum Cardiomyopathy

diagnosis-related relational information and data in said categories or headings □n

31. DIAGNOSIS Postpartum Cardiomyopathy

diagnosis-related relational information and data in said categories or headings □n

32. DIAGNOSIS Marfan's Syndrome Cardiomyopathy

diagnosis-related relational information and data in said categories or headings □n

33. DIAGNOSIS Toxins-Caused Cardiomyopathies

diagnosis-related relational information and data in said categories or headings □n

34. DIAGNOSIS Radiation Cardiomyopathy

diagnosis-related relational information and data in said categories or headings □n

wherein related to each of said categories or headings comprising interactive words and terms related to each said diagnoses are said interactive □n representative sequential ranking of interactive □1, □2, □3, □4, □5, . . . , □100 and □ unlikely, least likely, not likely, or please refer patient to physician named X or groups of physicians Y, etc. (for example, □1=represents most likely or must investigate and test first to □100=represents the least likely or least need to investigate and test) represents said computational processes and outcomes based on said relational information and data in said SQL database and/or databases. Similarly, said computer said computational processes and outcomes based on said relational information and data in said SQL database and/or databases in said computer server or servers are applied to said interactive and adaptable peripartum cardiomyopathy-related categories or headings representing diseases, disorders and illnesses treated and being treated by physicians and doctors in all about 85 medical and surgical specialties or practices.

Said representations including said interactive and adaptable relational information and data on said categories or headings comprising interactive words and terms related to said diagnoses or syndromes, in its most simplistic order represent a few guidelines and protocols among thousands to millions of computer-created and computer-generated interactive and adaptable guidelines and protocols repetitively generated in responses to physicians and patients using the present invention and are repetitively retrieved, viewed on viewing screens and used by any and all physicians and patients using said devices. As described supra for said pooled consensuses, this is due to the fact that the present invention created and generated said numerous guidelines and protocols related to individual diagnoses, individual syndromes, diagnoses and/or syndromes in individual groups of diagnoses and/or syndromes which are and can be inter-related as provided by the goals and objectives of the present invention said computer server, servers, virtual server and/or virtual servers enabled by said innovative computer programs and software. All diagnosis-related categories or headings comprising interactive words and terms said interactive and adaptable pooled guidelines and protocols in said relational information and data in said SQL database and/or databases are related and inter-related to computer-created and computer-generated a virtual three-dimensional arrays of computer-created, computer-generated and computer-revealed interactive and adaptable guidelines and protocols related to said computer-created, computer-generated and computer-revealed interactive and adaptable consensuses on diagnoses and syndromes on and related to diseases, disorders and illnesses treated and being treated and rendered by physicians and doctors in all about 85 medical and surgical specialties or practices in said computer server, servers, virtual server and/and/or virtual servers. Said virtual three-dimensional arrays are best computer-created, computer-generated and computer-revealed using the system and method taught in and by U.S. Pat. No. 6,132,218 wherein said computer-created, computer-generated and computer-revealed interactive and adaptable guidelines and protocols and said computer-created, computer-generated and computer-revealed interactive and adaptable consensuses are retrieved, revealed, displayed and used by physicians and patients as taught supra.

Statistical analyses, deductions, revelations and reports—using common statistical methods and programs commonly being used in medicine, health-care and sciences—on the accuracies on said outcomes of said processes and selections relating to said inputs of information and data by said people and computer-generations and computer-displays of said interactive and adaptable pooled consensuses, guidelines, protocols and derivatives and outcomes on and relating to individual diagnoses, individual syndromes and diagnoses or syndromes and said derivatives of successive and extensive computer-deductions on and related to individual groups of diagnoses or syndromes in about 85 medical and surgical specialties and practices by said computer server or servers are also provided by the present invention.

The present invention provides a process for retrieving and displaying on said viewing screens and enabling the uses, edits, updates, improvements, expansions and inspections of said individual compilations and pools of said relations of individual diagnoses, individual syndromes and diagnoses or syndromes in individual groups of diagnoses or syndromes and related diseases, disorders, differential diagnoses and chief complaints, symptoms and signs, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and practices by physicians using said devices and the Internet to access said computer server, servers, virtual server and/or virtual servers in said network or networks of computer servers and devices effected in and by said computer server or servers and effected by said Windows Server, SQL Server, Web server, Visual Studio and .Net, computer scripting languages, Java script, AJAX, HTML, XHTML and said innovative computer programs and software operating in said computer server or servers and at least a Web browser in said devices in said network or networks of computer servers and devices.

To repeat, it is factually reasonable and accurate to claim that at least one of the preferred embodiments of the present invention epitomizes and represents a truly first globally vast, complex and most intelligent computer-biological electronic-neural system and method comprising computer servers, virtual servers and devices in a network or networks of computer servers, virtual servers, devices and thousands to hundreds of thousands of physicians and billions of people using said network or networks of computer servers and virtual servers and devices possessing and operating improvable innovative computer programs, software and adaptable, improvable, expandable, immensely compiled, related and pooled relational information and data on medicine, health, health-care and health-care services for managing the optimal or the best qualities, quantities and deliveries of health, health-care and health-care services by physicians for billions of people. Further fact, the preferred embodiments of the present invention, in many settings and circumstances, exceed the performances and outputs of the memory, reasoning, deductive, analytical and logical capabilities of physicians' brains.

Said interactive and adaptable pooled consensuses, guidelines, protocols, system and methods provide coordinated managements and deliveries of health, health-care and health-care services by physicians and electronic-speedily and optimal deliveries of health, health-care and health-care services by individual physicians and individual groups of physicians and correct, optimal, coordinated and uniformly effective approaches to and choices of managements and treatments of diseases and disorders by individual physicians and individual groups of physicians and patients.

Said methods, processes, system, consensuses, guidelines, protocols, matters, products, functions and related and derivatives of the present invention are implemented and effected by said innovative computer software and programs invented and developed by the present patent applicant which were filed with and are stored in the Library of Congress in Washington, D.C. The present invention uses also the commercially available computer software (plural), programs and computer languages such as, but not limited to, those made and sold by Microsoft Corporation such as, but not limited to, Microsoft Windows Server, SQL such as, but not limited to Microsoft SQL Server, MySQL and the like, Internet Explorer, Web browsers, Web server, Apache, Microsoft IIS, Visual Studio and .Net, Microsoft software including Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML and the like and related and their derivatives. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software(s) mentioned herein operate. It is obvious and known that with more extensive operations, requirements and equipment, server blades and various hardware and equipment configurations, virtual servers such as those sold by VMware, HP and IBM, and their derivatives being used by many large American corporations can and will be used to implement the present invention.

Said preferred embodiments of the present invention are applicable to and used by individual physicians, individual patients, individual groups of physicians and individual groups of physicians and individual patients in same and diverse and different settings and locations. In other words, the preferred embodiments of the present invention are also enabled by popular commercial technologies provided www.webex.com by Cisco Systems, Inc. and www2.gotomeeting.com by Citrix Online, L.L.C. and the like provided by other companies or corporations for enabling individual persons in various and different settings and locations to conference or use said embodiments as individual groups of people being in said diverse or different settings and locations using said network or networks and the Internet to achieve the goals and objectives of the present invention.

Although sequences of applications of individual interactive words and terms representing diagnoses, syndromes and diagnoses or syndromes in individual groups of diagnoses or syndromes and compiled, related or pooled relational information and data on and related to diagnoses, syndromes and diagnoses or syndromes in individual groups of diagnoses or syndromes and related chief complaints, symptoms and signs, differential diagnoses, reviews of systems, physical examinations, family histories, genetics, immunizations, laboratories, imaging, body fluid tests and tissues examinations, assessments and plans, medications, treatments, procedures, surgeries, recommendations, guidelines, referrals, follow-ups, organs and anatomical sites and parts of humans and physicians' practices related to said diagnoses or said individual groups of diagnoses as one of the preferred embodiments of the present invention have been described, it is to be appreciated and understood by those skilled in the art that various combinations, permutations and orders of sequences of applications of said words, terms and phrases are some of the preferred embodiments of the present invention and are made, used and achieved without departing from the spirit and the scope of the claims of the present invention.

It is to be understood that a computer server, computer servers and/or virtual serves capable of computer-creating and -generating said consensuses, guidelines and protocol and computer-deducing diagnoses, syndromes and diagnoses or syndromes in individual groups of diagnoses or syndromes of the present invention also embody any and all computers and mobile computers such as, but not limited to, and server blades and various hardware and equipment configurations, virtual servers such as those sold by VMware, HP and IBM, and their derivatives being used by many large American corporations can and will be used to implement the present invention. Furthermore, it is to be understood that computer or computers in the claims infra also implied computer server, computer servers, virtual server, virtual servers so that, for example, computer-created, computer-generated, computer-automatically and computational processes, etc., infra are synonymous with or embody computer server-created, computer server-generated and computer server-automatically, virtual server-created, virtual server-generated and virtual server-automatically, server-computational processes and virtual server-computational processes, etc.

Although one of the preferred embodiments of this invention encompassed individual compiled and pooled computer-created consensuses, guidelines and protocols comprising interactive and adaptable electronic templates comprising said relational information and data in said database and/or databases retrievable, viewable on the viewing screens of computers, portable and wireless electronic communication devices and interactive with and useable by physicians and patients in said network or networks of said computers, portable and wireless electronic communication devices and computer servers, it is understood that one of the preferred embodiments of the present invention also include the non-electronic versions of said consensuses, guidelines and protocols such as, but not limited to, verbal, speech, voice, sound, illustrated, graphic and printed versions and any combinations thereof of said consensuses, guidelines and protocols available, audible, viewable and useable by physicians and patients to achieve the objectives and goals of the present invention.

Although the preferred embodiments of this invention have been described for humans, it will be appreciated by those skilled in the art that adaptations and variations of the present invention may be made to apply to other species, animals, biological entities or structures, infectious particles or structures, and machines without departing from the spirit of the invention and the scope of the claims.

Although various preferred embodiments and representations of the present invention have been described, it will be appreciated by those skilled in the art that the real and practical implementations and their adaptations, variations and derivatives are and will be made and achieved without departing from the spirit and the scope of the claims of the present invention.

1. A computerized electronic platform of interactive and adaptable pooled consensuses, guidelines and protocols on the qualities, quantities, managements and deliveries of health, health-care and health-care services for physicians created, generated, improved and maintained by and in a computer server or servers comprise compiled, related and pooled relational information and data in the SQL database and/or databases derived from individual physicians' submissions of individual diagnoses and related information and data on health, health-care and health-care services repetitively generated by individual physicians and submitted to and compiled, related and pooled in said SQL database and/or databases in a computer server or servers or virtual server comprising individual diagnoses, individual syndromes or diagnoses or syndromes in individual groups of diagnoses or syndromes and individual keys representing said individual diagnoses, individual syndromes or diagnoses or syndromes in individual groups of diagnoses or syndromes and related relational information and data on health, health-care and health-care services comprising no redundant duplicates or repeats, doubles related to in said SQL database and/or databases in and manage by said SQL Server in said computer server or servers wherein said pooled consensuses, guidelines and protocols are repetitively accessed, retrieved and viewed on the viewing screens of computers, portable and wireless electronic communication devices henceforth devices and used, updated, expanded and improved by said computer server or servers and physicians in a network or networks of computer servers and devices for expediting, facilitating, optimizing and effecting the processes of medical-decision making and managing diseases, disorders, health, health-care and health-care services of patients of physicians and for generating and submitting information and data on diagnoses, health, health-care and health-care services rendered to patients by physicians into said SQL database and/or databases for minimizing errors and wastes and losses of time and health-care resources by physicians comprises:
said computer servers possessing and operating memories, processors, at least a server operating system, a Windows Server, a SQL Server, a Visual Studio and .Net, computer scripting languages, Java script, AJAX, HTML, XHTML, a Microsoft IIS, Apache, a Web browser, Web server;
said computer servers possessing and operating the innovative computer programs and software for commanding and communicating for commanding and communicating with said SQL Server and said relational database and/or databases and coupling with said computer scripting language and for creating, compiling, pooling and relating information and data in SQL database and/or databases comprising individual diagnoses, individual syndromes or diagnoses in individual groups of diagnoses affecting organs, parts and anatomical sites of humans and related diseases, disorders, chief complaints, differential diagnoses and, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties or practices repetitively generated by physicians and submitted to, compiled, related and pooled in said SQL database and/or databases in and manage by said SQL Server and for repetitively scanning or checking for redundant duplicates or repeats, doubles in said physicians' submissions, for removing said redundant duplicates or repeats, doubles relating to individual diagnoses from said SQL database and/or databases, for not inserting said redundant duplicates or repeats, doubles relating to individual diagnoses in said SQL database and/or databases and for compiling, pooling and relating relational information and data in said SQL database and/or databases or tables and for repetitively creating, generating, managing, relating, updating, improving said relational information and data in said SQL database and/or databases and for repetitively creating, generating and displaying and enabling the uses of said individual interactive and adaptable electronic consensuses, guidelines and protocols in said computer server or servers;
said submissions of individual diagnoses and related information and data on health, health-care and health-care services comprise related chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations, physicians' specialties and practices;
interactive, adaptable and expandable first individual interactive and adaptable related electronic templates comprising interactive and adaptable categories and headings on related chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and practices generated in and by said computer server or servers for physicians to repetitively generate and submit information and data on and related to said categories and headings to said compiled, related and pooled relational data in said SQL database and/or databases using said viewing screens of said devices enabled by Web browsers and the Internet and said devices;
compiled, related and pooled relational data in said SQL database and/or databases in and manage by said SQL server in said computer server or servers;
said compiled, related and pooled relational data comprising individual diagnoses and individual syndromes and diagnoses or syndromes in individual groups of diagnoses or syndromes and related relational information and data in said categories, headers or headings in said SQL database and/or databases in and manage by said SQL server;
said compiled, related and pooled said relational data in said SQL database and/or databases comprising individual diagnoses, individual syndromes and diagnoses or syndromes in individual groups of diagnoses or syndromes and related said categories, headers or headings related to medical or surgical specialties or practices of physicians and in and manage by said SQL server;
said compiled, related and pooled relational data in said SQL database and/or databases comprising no redundant duplicates or repeats, doubles of or representing chief complaints, differential diagnoses, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations related to individual diagnoses, individual syndromes and diagnoses or syndromes in individual groups of diagnoses or syndromes;
said individual interactive and adaptable consensuses, guidelines and protocols comprise said compiled, related and pooled relational data in said SQL database and/or databases in and manage by said SQL Server in said computer server or servers;
said individual interactive and adaptable consensuses, guidelines and protocols comprise said compiled, related and pooled relational data created, generated, improved, updated, expanded and edited in and by said computer server or servers;
said individual interactive and adaptable consensuses, guidelines and protocols comprise said compiled, related and pooled relational data created and generated in and by said computer server or servers and improved, updated, expanded, edited and manipulated by physicians;
said interactive and adaptable said consensuses, guidelines and protocols comprising interactive, adaptable and expandable second individual related electronic templates comprising compiled, related and pooled relational data in said SQL database and/or databases; and
Web browsers for repetitively retrieving, displaying said interactive, adaptable and expandable related first electronic templates and said consensuses, guidelines and protocol comprising individual related second electronic templates and successive interactive, adaptable related electronic templates on Web pages on said viewing screens of said devices which are used by physicians and patients to edit, improve, update, expand and manage compiled, related and pooled relational information and data comprising said individual diagnoses, individual syndromes and diagnoses or syndromes in individual groups of diagnoses or syndromes and related information and data in said categories, headers or headings on and related to said patients in said SQL database and/or databases using said devices to communicate with and access said computer servers in said network or networks of computer servers and devices via the Internet.

2. The computerized electronic platform of interactive and adaptable pooled consensuses, guidelines and protocols according to claim 1 wherein said compiled, related and pooled relational data in said SQL database and/or databases in and manage by said SQL server in said computer server or servers comprises compiled, related and pooled relational data in said SQL database and/or databases comprising SQL-compiled and -pooled and -related individual diagnoses, individual syndromes and diagnoses in individual groups of diagnoses affecting organs, parts and anatomical sites of humans and related chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and/or practices repetitively generated by physicians and submitted to said computer server or servers wherein said submissions are compiled, related and pooled in said relational information and data in said SQL database and/or databases in and manage by said SQL Server in said computer server or servers.

3. The computerized electronic platform of interactive and adaptable pooled consensuses, guidelines and protocols according to claim 1 wherein said individual interactive and adaptable consensuses, guidelines and protocols comprise said compiled, related and pooled relational data comprise individual diagnoses and individual syndromes related chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals and recommendations and physicians' specialties and practices.

4. The computerized electronic platform of interactive and adaptable pooled consensuses, guidelines and protocols according to claim 1 wherein said individual interactive and adaptable consensuses, guidelines and protocols comprise said compiled, related and pooled relational data comprise diagnoses or syndromes in individual groups of diagnoses or syndromes affecting organs, parts and anatomical sites of humans and related chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals and recommendations and physicians' specialties and practices.

5. In the computerized electronic platform of interactive and adaptable pooled consensuses, guidelines and protocols on the qualities, quantities, managements and deliveries of health, health-care and health-care services for physicians created, generated, improved and maintained by and in a computer server or servers, a method for creating and repetitively generating individual adaptable and interactive pooled consensuses for managing and delivering health, health-care, health-care services to patients and individual adaptable and interactive pooled and guidelines and protocols for managing and treating diseases, disorders of and effects and side-effects of medications, drugs, chemicals and therapeutics on patients and health-care managements, services and practices of physicians in and by a computer server or computer servers enabled by the innovative programs and software and a SQL Server to transform, compile and pool related information and data in individual physicians' submissions comprising individual diagnoses and related differential diagnoses and chief complaints, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' practices repetitively generated by physicians using a plurality of first interactive and adaptable related electronic templates and submitted into the SQL database and/or databases as relational information and data represented by related individual keys representing individual words and terms in said SQL database and/or databases in and manage by said SQL Server in said computer server or computer servers and to scan and check for redundant duplicates or repeats, doubles related to individual diagnoses, individual syndromes and diagnoses or syndromes in individual groups of diagnoses or syndromes in said physicians' submissions against same or similar information and data in said SQL database and/or databases and to cause redundant duplicates or repeats, doubles related to individual diagnoses or individual syndromes or diagnoses in individual groups of diagnoses to be removed or not be inserted into said SQL database and/or databases comprising no said redundant duplicates or repeats, doubles and to compile, relate and pool said relational information and data into compilations, relations and pools of relational information and data and to repetitively insert, compile, pool and relate additional submissions, updates, editions and improvements repetitively generated and submitted by physicians into said compilations, relations and pools of relational information and data in said SQL database and/or databases and to effect the repetitive retrievals, displays and uses of said compilations, pools, relations and related updates, editions and improvements as said consensuses, guidelines and protocols comprising individual second interactive and adaptable computer-generated electronic templates on the viewing screens of said devices by physicians on the viewing screens of computers, portable and wireless electronic communication devices henceforth devices enabled by the Web browsers to repetitively access, retrieve and view on said viewing screens, use said consensuses, guidelines and protocols by physicians and to edit, update, expand and improve said consensuses, guidelines and protocols by letting and enabling physicians to repetitively use, update, add to or edit relational data in said SQL database and/or databases appearing in said consensuses, guidelines and protocols representing said compilations, pools, relations and related updates, editions and improvements in said SQL database and/or databases and to let and enable any physicians to adapt said pooled consensuses, guidelines and protocols to suit said any physicians' uses, preferences and needs or requirements of said consensuses, guidelines and protocols accessible by physicians using said devices in said network or networks of computer servers and devices and the Internet to expedite, facilitate, optimize and effect the processes for medical-decision making and managing diseases, disorders, health, health-care and health-care services of patients of physicians and to generate and submit information and data on diagnoses, health, health-care and health-care services rendered to patients by physicians into said SQL database and/or databases in and manage by said SQL Server in said computer server or servers to minimize errors and wastes and losses of health-care time and resources by physicians comprises:
a process for operating computer servers possessing and operating memories, processors, at least a server operating system, a Windows Server, a SQL Server, a Visual Studio and .Net, computer scripting languages, Java script, AJAX, HTML, XHTML, a Microsoft IIS, a Web browser, Web server in said network or networks of computer servers and devices;
a process for operating in said computer server or servers the innovative computer programs and software for commanding and communicating with said SQL Server and said relational database and/or databases and coupling with said computer scripting language and for creating, compiling, pooling and relating relational data in said SQL database and/or databases in and manage by said SQL Server, for repetitively scanning and checking for redundant duplicates or repeats, doubles in individual physicians' submissions related to individual diagnoses or individual syndromes and diagnoses or syndromes in individual groups of diagnoses or syndromes and related relational data in said SQL database and/or databases, for removing said redundant duplicates or repeats, doubles from relational data in said SQL database and/or databases or for not inserting said redundant duplicates or repeats, doubles into said relational data in said SQL database and/or databases and for compiling, pooling and relating relational data in said SQL database and/or databases, for managing, matching and selecting keys in said relational data, for compiling, relating and pooling related keys in said relational data, for repetitively creating, generating, managing, relating, improving said relational data, for generating, improving, updating and inserting additional data into said compiled, related and pooled relational data in said SQL database and/or databases, for generating and displaying compiled, related and pooled relational data as individual consensuses, guidelines and protocols and for creating, generating and displaying, for enabling the uses of said consensuses, guidelines and protocols in said computer server or servers by physicians using said devices and for editing, improving, updating, expanding and managing compiled, related and pooled relational data in said SQL database and/or databases by physicians and patients using said devices to communicate with and access said computer servers in said network or networks of computer servers and devices via the Internet;
a process for compiling, relating and pooling relational data in said SQL database and/or databases in and manage by said SQL server comprising SQL-compiled, -related and -pooled individual diagnoses, individual syndromes and diagnoses in individual groups of diagnoses affecting organs, parts and anatomical sites of humans and related chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties or practices in said SQL database and/or databases in and manage by said SQL Server in said computer server or servers;
a process for transforming individual physicians' submissions in said computer server or servers into SQL-compiled, -related and -pooled relational data in said SQL database and/or databases comprising keys in said SQL database and/or databases representing individual diagnoses, individual syndromes and diagnoses in individual groups of diagnoses affecting organs, parts and anatomical sites of humans and related chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations, physicians' specialties and/or practices in said SQL database and/or databases in and manage by said SQL Server in said computer server or servers effected by said innovative computer programs and software and SQL server;
a process for using said keys in said SQL database and/or databases to create, relate and pool relational data comprising individual relations of keys representing individual diagnoses, individual syndromes and diagnoses in individual groups of diagnoses affecting organs, parts and anatomical sites of humans and related diseases, disorders, differential diagnoses and chief complaints, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations, physicians' specialties and/or practices in said SQL database and/or databases in and manage by said SQL Server effected by said computer server or servers operating said innovative computer programs and software and SQL server;
a process for computer-automatically scanning and checking for redundant duplicates or repeats, doubles of or representing chief complaints, differential diagnoses, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations related to said diagnoses and syndromes in said individual physicians' submissions effected by said computer server or servers operating said innovative computer programs and software and SQL server;
a process for computer-automatically removing said redundant duplicates, doubles or repeats related to said diagnoses, syndromes and diagnoses in individual groups of diagnoses from said relational data in said SQL database and/or databases effected by said computer server or servers operating said innovative computer programs and software and SQL server;
a process for computer-automatically not inserting said redundant duplicates, doubles or repeats related to said diagnoses, syndromes and diagnoses in individual groups of diagnoses into said relational data in said SQL database and/or databases effected by said computer server or servers operating said innovative computer programs and software and SQL server;
a process for computer-automatically showing erroneous words and terms generated and submitted by physicians on said viewing screens of said devices so that said physicians are able to change, correct or edit said erroneous words and terms to result in correct words and terms in said SQL database and/or databases effected by said innovative computer programs and software operating in said computer server or servers;
a process for creating and generating said individual interactive and adaptable pooled consensuses and said individual interactive and adaptable pooled guidelines and protocols in and by said computer server or servers comprising said individual compilations and pools of related relational data on individual diagnoses, individual syndromes and diagnoses in individual groups of diagnoses affecting organs, parts and anatomical sites of humans and related diseases, disorders, differential diagnoses and chief complaints, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and/or practices in said SQL database and/or databases in and manage by said SQL Server effected by said computer server or servers operating said innovative computer programs and software and SQL server in said network or networks of computer servers and devices;
a process for repetitively creating, generating, retrieving and displaying said pooled consensuses and said individual pooled guidelines and protocols comprising said compiled, pooled and related relational data on said viewing screens of said devices and enabling the uses of said individual interactive and adaptable electronic consensuses, guidelines and protocols by physicians using said devices to access said consensuses, guidelines and protocols in said computer server or servers;
a process for creating, generating and displaying on said viewing screens said individual interactive and adaptable pooled consensuses, guidelines and protocols by and in said computer server or servers effected by said Windows Server, SQL Server, Web server, Visual Studio and .Net, computer scripting languages, Java script, AJAX, HTML, XHTML and said innovative computer programs and software operating in said computer server or servers and at least a Web browser in said devices in said network or networks of computer servers and devices;
a process for repetitively retrieving, displaying, viewing and using said adaptable consensuses, guidelines and protocols on said viewing screens of said devices by physicians and patients;
a process for repetitively editing, inserting, improving, updating, expanding and managing said relational data in said SQL database and/or databases effected by said computer server or servers operating said innovative computer programs and software and SQL server;
a process for generating interactive, adaptable and expandable individual interactive and adaptable related electronic templates effected by said SQL database and/or databases, said SQL Server, JAVA script, AJAX, HTML, PHP and said innovative computer software and program in said computer server or servers and Internet Explorer and browsers;
a process for using interactive, adaptable and expandable first individual interactive and adaptable related electronic templates comprising interactive and adaptable categories and headings on and related to chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and practices generated in and by said computer server or servers for physicians to repetitively generate and submit information and data on and related to said categories and headings to said compiled, related and pooled relational data in said SQL database and/or databases using said viewing screens of said devices enabled by Web browsers and the Internet and said devices;
a process for repetitively displaying on said viewing screens of said devices and using said interactive and adaptable consensuses, guidelines and protocols comprising interactive, adaptable and expandable second individual related electronic templates comprising compiled, related and pooled relational data in said SQL database and/or databases by physicians;
a process for using Web browsers for repetitively retrieving, displaying said interactive, adaptable and expandable first individual interactive and adaptable related electronic templates and said consensuses, guidelines and protocols comprising said second individual interactive and interactive and adaptable related electronic templates and successive related electronic templates on Web pages on said viewing screens of said devices which are used by physicians and patients to edit, improve, update, expand and manage said compiled, related and pooled relational data in said SQL database and/or databases using said devices to communicate with and access said computer servers in said network or networks of computer servers and devices via the Internet;
a process for using said devices enabled by the Web browsers for repetitively retrieving, displaying said interactive, adaptable and expandable first individual interactive and adaptable related electronic templates and second individual related electronic templates and successive related electronic templates on Web pages on said viewing screens of said devices which are used by physicians and patients to edit, improve, update, expand and manage said compiled, related and pooled relational data in said SQL database and/or databases using said devices to communicate with and access said computer servers in said network or networks of computer servers and devices via the Internet;
a process for using said devices enabled by the Web browsers for repetitively retrieving, displaying, editing, updating and improving said outcomes of said processes on the viewing screens of said devices which are used by physicians and patients to edit, improve, update, expand and manage said compiled, related and pooled relational data in said SQL database and/or databases using said devices to communicate with and access said computer servers in said network or networks of computer servers and devices via the Internet;
a process for using said devices enabled by the Web browsers for repetitively retrieving, displaying, editing, updating, improving, viewing and using said outcomes of said processes on Web pages on the viewing screens of said devices and to expedite and improve medical-decision and health-care processes and the managements of said health-care services and deliveries to patients by physicians and said patients and to reduce physical, mental and financial stresses and strains on physicians and patients using said devices to communicate with and access said computer servers in said network or networks of computer servers and devices via the Internet; and
a process for locating or positioning—wherever feasible, achievable, workable or practicable—interactive functions, panels and tools and information and data health, health-care, health-care services and communications in said consensuses, guidelines and protocols and interactive and adaptable electronic templates to physicians and patients in the right half or area of said viewing screens including touch-enabled screens or touchscreens of said devices.

6. The method according to claim 5 wherein said process for creating and generating said individual interactive and adaptable pooled consensuses and said individual interactive and adaptable pooled guidelines and protocols in and by said computer server or servers comprising said individual compilations and pools of related relational data on individual diagnoses, individual syndromes and diagnoses in individual groups of diagnoses affecting organs, parts and anatomical sites of humans and related diseases, disorders, differential diagnoses and chief complaints, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and/or practices in said SQL database and/or databases comprises a process for assigning keys in said SQL database and/or databases to said individual diagnoses and individual syndromes and diagnoses in individual groups of diagnoses and related chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs, chemicals and therapeutics including effects and side-effects of said medications, drugs, chemicals and therapeutics, guidelines, protocols, referrals, recommendations, health, health-care, health-care services, specialties and practices in said SQL database and/or databases in and manage by said SQL Server.

7. The process for assigning keys in said SQL database and/or databases according to claim 6 comprises a process for assigning individual primary, foreign and surrogate keys in said SQL database and/or databases to said individual diagnoses, individual syndromes and diagnoses in individual groups of diagnoses affecting organs, parts and anatomical sites of humans and related diseases, disorders, differential diagnoses and chief complaints, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations, physicians' specialties and practices in said SQL database and/or databases in and manage by said SQL Server.

8. The method according to claim 5 wherein said process for creating and generating said individual interactive and adaptable pooled consensuses and said individual interactive and adaptable pooled guidelines and protocols in and by said computer server or servers comprises a process for relating said individual primary, foreign and surrogate keys and compiling and pooling said related keys in said SQL database and/or databases in and manage by said SQL Server.

9. The method according to claim 5 wherein said process for creating and generating said individual interactive and adaptable pooled consensuses and said individual interactive and adaptable pooled guidelines and protocols in and by said computer server or servers comprises a process for repetitively computer-creating and computer-generating said compiled, pooled and related relational data which are retrieved and displayed on said viewing screens of said devices and used by physicians using said devices to access said consensuses, guidelines and protocols in said computer server or servers.

10. The method according to claim 5 wherein said process for computer-automatically scanning and checking for redundant duplicates, repeats, doubles or similars of or representing chief complaints, differential diagnoses, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations related to said diagnoses and syndromes in said individual physicians' submissions comprises a process for computer-automatically scanning or checking said individual submissions with same as, similar to and/or equivalent information and data in said SQL database and/or databases for redundant duplicates, repeats, doubles or similars effected by said innovative computer programs and software operating in said computer server or servers.

11. The method according to claim 5 wherein said process for creating, generating and displaying on said viewing screens said individual interactive and adaptable pooled consensuses, guidelines and protocols by and in said computer server or servers effected by said Windows Server, SQL Server, Web server, Visual Studio and .Net, computer scripting languages, Java script, AJAX, HTML, XHTML and said innovative computer programs and software operating in said computer server or servers and at least a Web browser in said devices in said network or networks of computer servers and devices comprises a process for generating and displaying said individual interactive and adaptable pooled consensuses, guidelines and protocols as second individual interactive, adaptable and expandable electronic templates for displaying on said viewing screens and enabling the uses, edits, updates, improvements and expansions of said individual compilations and pools of said relations of individual diagnoses, individual syndromes and diagnoses in individual groups of diagnoses and related diseases, disorders, differential diagnoses and chief complaints, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and practices by physicians using said devices to access said computer server or servers in said network or networks of computer servers and devices.

12. In the computerized electronic platform of interactive and adaptable pooled consensuses, guidelines and protocols on the qualities, quantities, managements and deliveries of health, health-care and health-care services for physicians created, generated, improved and maintained by and in a computer server or servers, a method for computer-deducing individual diagnoses of diseases, disorders, individual syndromes and diagnoses or syndromes in individual groups of diagnoses or syndromes affecting organs, parts and anatomical sites of humans and for computer-managing treatments of diseases and disorders and deliveries of health, health-care and health-care services by physicians using individual computer-created and computer-generated interactive and adaptable pooled consensuses for computer-deducing said individual diagnoses, individual syndromes and diagnoses or syndromes in individual groups of diagnoses or syndromes and computer-created and computer-generated individual interactive and adaptable pooled guidelines and protocols for computer-managing said treatments and deliveries comprising compiled, related and pooled relational information and data in the SQL database and/or databases in and manage by a SQL Server in said computer server or computer servers accessible by physicians using computers, portable and wireless electronic communication devices henceforth devices in a network or networks of said computer servers and devices and the Internet to retrieve, display, use and improve said consensuses, guidelines and protocols as second individual interactive and adaptable computer-generated electronic templates on the viewing screens of said devices by physicians for expediting, facilitating, optimizing and congruently effecting the processes of medical-decision making and managing diseases, disorders, health, health-care and health-care services by physicians and to generate and submit the information and data comprising health, health-care and health-care services in said consensuses, guidelines and protocols into relational information and data on or relating to patients in said SQL database and/or databases in and manage by said SQL Server in said computer server or servers to minimize errors and wastes and losses of time and health-care resources by physicians comprises:
a process for operating computer servers possessing and operating memories, processors, at least a server operating system, a Windows Server, a SQL Server, a Visual Studio and .Net, computer scripting languages, Java script, AJAX, HTML, XHTML, a Microsoft IIS, a Web browser, Web server in said network or networks of computer servers and devices;
a process for operating in said computer server or servers the innovative computer programs and software for commanding and communicating with said SQL Server and said relational database and/or databases and coupling with said computer scripting language and for creating, compiling, pooling and relating relational data in said SQL database and/or databases in and manage by said SQL Server, for repetitively scanning and checking for redundant duplicates or repeats, doubles in individual physicians' submissions related to individual diagnoses or individual syndromes and diagnoses or syndromes in individual groups of diagnoses or syndromes and related relational data in said SQL database and/or databases, for removing said redundant duplicates or repeats, doubles from relational data in said SQL database and/or databases for not inserting said redundant duplicates or repeats, doubles into said relational data in said SQL database and/or databases and for compiling, pooling and relating relational data in said SQL database and/or databases, for managing, matching and selecting keys in said relational data, for compiling, relating and pooling related keys in said relational data, for repetitively creating, generating, managing, relating, improving said relational data, for generating, improving, updating and inserting additional data into said compiled, related and pooled relational data in said SQL database and/or databases, for generating and displaying compiled, related and pooled relational data as individual consensuses, guidelines and protocols and for creating, generating and displaying, for enabling the uses of said consensuses, guidelines and protocols in said computer server or servers by physicians using said devices and for editing, improving, updating, expanding and managing compiled, related and pooled relational data in said SQL database and/or databases by physicians and patients using said devices to communicate with and access said computer servers in said network or networks of computer servers and devices via the Internet;
a process for using interactive, adaptable and expandable first individual interactive and adaptable related electronic templates comprising interactive and adaptable categories and headings on and related to chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and practices henceforth physicians' submissions generated in and by said computer server or servers for physicians to repetitively generated and submitted to said compiled, related and pooled relational data in said SQL database and/or databases using said viewing screens of said devices enabled by Web browsers and the Internet and said devices;
a process for effecting individual physicians' submissions comprising individual diagnoses and related chief complaints, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and/or physicians' specialties and practices repetitively generated by physicians and submitted by using a plurality of first individual interactive and adaptable related electronic templates into compiled, related and pooled relational information and data in said SQL database and/or databases in and manage by said SQL Server in said computer server or servers;
a process for transforming said individual physicians' submissions effected by the Stored Procedures of said SQL Server and said innovative computer programs and software into compiled, related and pooled relational data in said SQL database and/or databases;
a process for computer-creating and computer-generating individual diagnoses of diseases, disorders, individual syndromes and diagnoses or syndromes in individual groups of diagnoses or syndromes affecting organs, parts and anatomical sites of humans and related diseases, disorders, chief complaints, differential diagnoses, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and/or physicians' specialties and practices by compiling, relating and pooling related data in said SQL database and/or databases enabled by said computer server or servers operating the innovative computer programs and software and said SQL Server;
a process for scanning and checking for redundant duplicates or repeats, doubles related to individual diagnoses or individual syndromes in individual physicians' submissions against same or similar information and data in said SQL database and/or databases to cause redundant duplicates or repeats, doubles to be removed or not be inserted by said computer server or servers into said SQL database and/or databases comprising said redundant duplicates or repeats, doubles related to individual diagnoses, individual syndromes or diagnoses or syndromes in individual groups of diagnoses or syndromes enabled by said computer server or servers operating the innovative computer programs and software and said SQL Server;
a process for retrieving, displaying and viewing said consensuses, guidelines and protocols comprising individual diagnoses of diseases, disorders, individual syndromes and diagnoses or syndromes in individual groups of diagnoses or syndromes and compiled, related and pooled relational information and data in said SQL database and/or databases on the viewing screens of devices by physicians enabled by the Web browsers;
a process for editing, updating, expanding and improving said relational information and data in said SQL database and/or databases by said computer server or servers;
a process for editing, updating, expanding and improving said relational information and data in said SQL database and/or databases by physicians;
a process for adapting said compiled and pooled relational data in said SQL database and/or databases as appearing in said pooled consensuses, guidelines and protocols by physicians to suit said physicians' uses, preferences and needs or requirements of said relational data in said adapted consensuses, guidelines and protocols;
a process for generating interactive, adaptable and expandable individual interactive and adaptable related electronic templates effected by said SQL database and/or databases, said SQL Server, JAVA script, AJAX, HTML, PHP and said innovative computer software and program in said computer server or servers and Internet Explorer and browsers;
a process for repetitively displaying on said viewing screens of said devices and using said interactive and adaptable consensuses, guidelines and protocols comprising second individual interactive, adaptable and expandable related electronic templates comprising compiled, related and pooled relational information and data in said SQL database and/or databases by physicians;
a process for repetitively displaying on said viewing screens of said devices and using said interactive and adaptable consensuses, guidelines and protocols comprising interactive, adaptable and expandable second individual related electronic templates comprising compiled, related and pooled relational information and data in said SQL database and/or databases by physicians to update, edit, expand, improve compiled, related and pooled relational information and data on and relating to individual patients in the SQL database and/or databases in and manage by said SQL Server;
a process for using Web browsers for repetitively retrieving, displaying said interactive, adaptable and expandable first individual interactive and adaptable related electronic templates and said consensuses, guidelines and protocols comprising said second individual interactive and interactive and adaptable related electronic templates and successive related electronic templates on Web pages on said viewing screens of said devices which are used by physicians and patients to edit, improve, update, expand and manage said compiled, related and pooled relational data in said SQL database and/or databases using said devices to communicate with and access said computer servers in said network or networks of computer servers and devices via the Internet;
a process for using said devices enabled by the Web browsers for repetitively retrieving, displaying, editing, updating and improving said outcomes of said processes on the viewing screens of said devices use by physicians and patients to edit, improve, update, expand and manage said compiled, related and pooled relational data in said SQL database and/or databases using said devices to communicate with and access said computer servers in said network or networks of computer servers and devices via the Internet;
a process for using said devices enabled by the Web browsers for repetitively retrieving, displaying, editing, updating, improving, viewing and using said outcomes of said processes on Web pages on the viewing screens of said devices and to expedite and improve medical-decision and health-care processes and the managements of said health-care services and deliveries to patients by physicians and said patients and to reduce physical, mental and financial stresses and strains on physicians and patients using said devices to communicate with and access said computer servers in said network or networks of computer servers and devices via the Internet; and
a process for locating or positioning—wherever feasible, achievable, workable or practicable—interactive functions, panels and tools and information and data health, health-care, health-care services and communications in said consensuses, guidelines and protocols and interactive and adaptable electronic templates to physicians and patients in the right half or area of said viewing screens including touch-enabled screens or touchscreens of said devices.

13. The method according to claim 12 wherein said process for transforming said individual physicians' submissions effected by the Stored Procedures of said SQL Server and said innovative computer programs and software into compiled, related and pooled relational data in said SQL database and/or databases comprises a process for representing individual words and terms in said individual physicians' submissions by individual keys in said SQL database and/or databases in and manage by said SQL Server.

14. The method for computer-deducing individual diagnoses of diseases, disorders, individual syndromes and diagnoses or syndromes in individual groups of diagnoses or syndromes according to claim 12 comprise a process for managing, matching and selecting related keys in said relational information and data in said SQL database and/or databases in and manage by said SQL server and enabled by said innovative computer programs and software in said computer server or servers.

15. The method according to claim 12 wherein said process for editing, updating, expanding and improving said relational information and data in said consensuses, guidelines and protocols by physicians comprises a process for repetitively editing, updating, expanding and improving said relational information and data in said SQL database and/or databases.

16. The process for repetitively editing, updating, expanding and improving said relational information and data in said SQL database and/or databases according to claim 15 comprises a process for repetitively retrieving, viewing on said viewing screens and using a plurality of first individual interactive and adaptable related electronic templates by individual physicians to generate and submit individual physicians' submissions to edit, update, expand and improve said relational information and data in said SQL database and/or databases in and manage by said SQL Server.

17. The method according to claim 12 wherein said process for editing, updating, expanding and improving said relational information and data in said consensuses, guidelines and protocols by said computer server or servers comprises a process for repetitively editing, updating, expanding and improving said relational information and data in and by said computer server or servers compiling, relating and pooling individual physicians' submissions generated and submitted into said SQL database and/or databases in and manage by said SQL server in said computer server or servers.

18. The method for computer-deducing individual diagnoses and individual syndromes according to claim 12 comprises a process for scanning and comparing diagnosis-related anatomical sites without redundant duplicates, doubles and repeats, diagnosis-related chief complaints without redundant duplicates, doubles and repeats, diagnosis-related symptoms and signs without redundant duplicates, doubles and repeats, diagnosis-related reviews of systems without redundant duplicates, doubles and repeats, diagnosis-related physical examinations without redundant duplicates, doubles and repeats and diagnosis-related laboratories including imaging, body fluids and tissues tests, diagnosis-related family histories without redundant duplicates, doubles and repeats, diagnosis-related physiology without redundant duplicates, doubles and repeats, diagnosis-related genetics without redundant duplicates, doubles and repeats, diagnosis-related immunizations without redundant duplicates, doubles and repeats, diagnosis-related treatments without redundant duplicates, doubles and repeats, diagnosis-related surgeries without redundant duplicates, doubles and repeats, diagnosis-related procedures without redundant duplicates, doubles and repeats, diagnosis-related medications without redundant duplicates, doubles and repeats, drugs and therapeutics and effects and side-effects on human organs and bodies of said medications, drugs and therapeutics without redundant duplicates, doubles and repeats, diagnosis-related guidelines without redundant duplicates, doubles and repeats, diagnosis-related protocols without redundant duplicates, doubles and repeats, diagnosis-related referrals without redundant duplicates, doubles and repeats, diagnosis-related recommendations without redundant duplicates, doubles and repeats and diagnosis-related physicians' specialties and practices without redundant duplicates, doubles and repeats in said relational information and data in said SQL database and/or databases in said computer server or servers.

19. The method for computer-deducing individual diagnoses and individual syndromes according to claim 12 comprises a process for compiling, relating and pooling diagnosis-related anatomical sites without redundant duplicates, doubles and repeats, diagnosis-related chief complaints without redundant duplicates, doubles and repeats, diagnosis-related symptoms and signs without redundant duplicates, doubles and repeats, diagnosis-related reviews of systems without redundant duplicates, doubles and repeats, diagnosis-related physical examinations without redundant duplicates, doubles and repeats and diagnosis-related laboratories including imaging, body fluids and tissues tests, diagnosis-related family histories without redundant duplicates, doubles and repeats, diagnosis-related physiology without redundant duplicates, doubles and repeats, diagnosis-related genetics without redundant duplicates, doubles and repeats, diagnosis-related immunizations without redundant duplicates, doubles and repeats, diagnosis-related treatments without redundant duplicates, doubles and repeats, diagnosis-related surgeries without redundant duplicates, doubles and repeats, diagnosis-related procedures without redundant duplicates, doubles and repeats, diagnosis-related medications without redundant duplicates, doubles and repeats, drugs and therapeutics and effects and side-effects on human organs and bodies of said medications, drugs and therapeutics without redundant duplicates, doubles and repeats, diagnosis-related guidelines without redundant duplicates, doubles and repeats, diagnosis-related protocols without redundant duplicates, doubles and repeats, diagnosis-related referrals without redundant duplicates, doubles and repeats, diagnosis-related recommendations without redundant duplicates, doubles and repeats and diagnosis-related physicians' specialties and practices without redundant duplicates, doubles and repeats in said relational information and data in said SQL database and/or databases in said computer server or servers related to said individual diagnoses and individual syndromes.

20. The method for computer-deducing diagnoses or syndromes in individual groups of diagnoses or syndromes according to claim 12 comprises a process for compiling, relating and pooling diagnosis-related anatomical sites without redundant duplicates, doubles and repeats, diagnosis-related chief complaints without redundant duplicates, doubles and repeats, diagnosis-related symptoms and signs without redundant duplicates, doubles and repeats, diagnosis-related reviews of systems without redundant duplicates, doubles and repeats, diagnosis-related physical examinations without redundant duplicates, doubles and repeats and diagnosis-related laboratories including imaging, body fluids and tissues tests, diagnosis-related family histories without redundant duplicates, doubles and repeats, diagnosis-related physiology without redundant duplicates, doubles and repeats, diagnosis-related genetics without redundant duplicates, doubles and repeats, diagnosis-related immunizations without redundant duplicates, doubles and repeats, diagnosis-related treatments without redundant duplicates, doubles and repeats, diagnosis-related surgeries without redundant duplicates, doubles and repeats, diagnosis-related procedures without redundant duplicates, doubles and repeats, diagnosis-related medications without redundant duplicates, doubles and repeats, drugs and therapeutics and effects and side-effects on human organs and bodies of said medications, drugs and therapeutics without redundant duplicates, doubles and repeats, diagnosis-related guidelines without redundant duplicates, doubles and repeats, diagnosis-related protocols without redundant duplicates, doubles and repeats, diagnosis-related referrals without redundant duplicates, doubles and repeats, diagnosis-related recommendations without redundant duplicates, doubles and repeats and diagnosis-related physicians' specialties and practices without redundant duplicates, doubles and repeats in said relational information and data in said SQL database and/or databases in said computer server or servers related to said diagnoses or syndromes in individual groups of diagnoses or syndromes affecting organs, parts and anatomical sites of humans and related diseases, disorders.
